(19) United States
(12) Patent Application Publication
(10) Pub. No.: US 2008/0101605 A1
(43) Pub. Date: May 1, 2008

(54) Storage system provided with an encryption function

(76) Inventors: Manabu Kitamura, Kawasaki (JP); Naoto Matsunami, Hayama (JP); Harumi Morino, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/638,380

(22) Filed: Dec. 14, 2006

(30) Foreign Application Priority Data
Oct. 25, 2006 (JP) 2006-289725

(51) Int. Cl. H04N 7/167

(52) U.S. Cl. 380/239

(57) ABSTRACT

A first storage system is provided with a first storage device containing an encryption processing unit, and a controller having an encryption processing unit and an access control unit. The access control unit judges whether a writing destination in the case of having processed a write request from an upper-level device is a first logical volume or a second logical volume, and in the case of having judged to be a first logical volume, transmits write data to a first storage device corresponding to the first logical volume without encrypting in the encryption processing unit of the controller, while on the other hand, in the case of having judged the writing destination to be a second logical volume, transmits the write data to a second storage system after having encrypted the target writing data with the encryption processing unit of the controller.

### CROSS-REFERENCE TO PRIOR APPLICATION

This application relates to and claims the benefit of priority from Japanese Patent Application No. 2006-289725, filed on Oct. 25, 2006, the entire disclosure of which is incorporated herein by reference.

### BACKGROUND

The present invention relates to a storage system provided with a plurality of storage devices.

At organizations such as private corporations, storage systems that are externally connected to host computers (to be referred to as “hosts”) are used to manage large amounts of data. These storage systems contain a large number of hard disk drives and other storage devices, and are able to provide a large-capacity storage area to a host by a controller.

Various types of important information, such as personal information including names and addresses of individuals as well as information relating to credit rating and so on, are stored in storage systems. Thus, technology is required which maintains the confidentiality of this important information and prevents unauthorized access thereto.

Encryption technology may be used to protect data. Unauthorized use of data by a third person can be prevented by encrypting data within a host and transmitting this encrypted data to a storage system for storage.

However, when data is encrypted within a host, the data processing load of the host ends up increasing, which in turn has a detrimental effect on the performance of application programs and other programs running on the host.

Therefore, technologies have been proposed which attempt to carry out encryption of data within a storage system as in, for example, Japanese Patent Application Laid-open No. 2005-322201.

One possible method for achieving this consists of encrypting write data in accordance with a write request and storing the data in a storage device each time a controller of a storage system receives a write request from a host. In this method, however, in comparison with the case of the storage system storing write data without encrypting, the load on the controller is large and the performance (such as the processing speed of write requests) of the controller ends up deteriorating. Since storage systems provide a large-capacity storage area, they receive large amounts of data in short periods of time, and in such cases in particular, it is difficult to encrypt that large amount of data while suppressing deterioration of controller performance.

In addition, a technology is known in which a second storage system is connected to a first storage system which receives write requests from a host, and data is copied from the first storage system to the second storage system. In addition, there are also cases in which data received by a first storage system from a host is transmitted to a second storage system. In these cases, to protect the data, it is preferable to store data in the encrypted form in the second storage systems to protect the data.

### SUMMARY

Thus, an object of the present invention is to reduce the processing load of a controller required for encrypting data stored inside and outside a storage device of a first storage system.

Additional objects of the present invention will be clear from the following descriptions.

A plurality of first storage devices provided in a first storage system are storage devices provided with an internal encryption processing unit. A first logical volume is prepared on the basis of this plurality of first storage devices. On the other hand, a second storage system has a plurality of second storage devices, and a second logical volume is prepared on the basis of this plurality of second storage devices.

The first storage system is provided with a controller having an encryption processing unit and an access control unit. The access control unit controls writing of data in accordance with write requests received from upper-level devices (such as a host computer or other storage system).

The access control unit judges whether a writing destination in the case of having processed a write request from a upper-level device is to be the first logical volume or the second logical volume.

In the case the writing destination has been judged to be the first logical volume, the access control unit transmits write data in accordance with the write request to the first storage device corresponding to the first logical volume without encrypting in the encryption processing unit of the controller. As a result, the write data is encrypted by the encryption processing unit of the first storage device and then stored in the first storage device.

On the other hand, in the case the writing destination has been judged to be the second logical volume, the access control unit transmits the write data to the second storage system after being encrypted by the encryption processing unit of the controller.

The access control unit and encryption processing unit can be constructed from hardware, a computer program or a combination thereof (for example, a portion of the access control unit may be realized by a computer program, while the remainder is realized with hardware). The computer program is executed by a predetermined processor after reading. In addition, a storage area present in memory or other hardware resource may be suitably used during information processing carried out by a computer program being loaded into a processor. In addition, a computer program may be installed in a computer from a CD-ROM or other recording medium, or may be downloaded to a computer via a communication network.

### BRIEF DESCRIPTION OF THE DRAWINGS

FIG. 1 shows an example of the physical configuration of a computer system as claimed in a first embodiment of the present invention;

FIG. 2 shows an example of the logical configuration of a computer system as claimed in a first embodiment of the present invention;

FIG. 3A shows an example of the configuration of a HDD 16;

FIG. 3B shows an example of the configuration of a key management table 160;

FIG. 4 is a drawing showing an example of the relationship between a plurality of HDD 16 and a logical volume;

FIG. 5 shows an example of the configuration of a RAID configuration table;

FIG. 6 shows an example of the configuration of a VDEV configuration table;

FIG. 7 shows an example of the configuration of an LU configuration table;

FIG. 8A shows an example of the configuration of a port configuration table;

FIG. 8B shows an example of the configuration of an EDEV data table;

FIG. 9 shows an example of the configuration of an EDEV configuration table;

FIG. 10 shows an example of the flow of LDEV creation processing;

FIG. 11 shows an example of the flow of processing carried out in the case of a host adapter 11 having received an I/O request from a host 4;

FIG. 12 shows an example of the flow of internal LDEV I/O processing;

FIG. 13 shows an example of the flow of external LDEV I/O processing;

FIG. 14 shows an example of writing processing of an HDD 16;

FIG. 15 shows an example of reading processing of an HDD 16;

FIG. 16 shows an example of the configuration of a pair configuration table;

FIG. 17 shows an example of the flow of pair formation processing;

FIG. 18 shows an example of the flow of initial copy processing;

FIG. 19 shows an example of the flow of update copy processing;

FIG. 20 shows an example of failback processing;

FIG. 21 shows an example of the physical configuration of a computer system as claimed in a second embodiment of the present invention;

FIG. 22 shows an example of the configuration of a LU configuration table in a second embodiment;

FIG. 23 shows an example of the flow of LDEV creation processing in a second embodiment;

FIG. 24 is an explanatory drawing of an automatic capacity expansion technology in a third embodiment of the present invention;

FIG. 25 shows an example of the configuration of an HDEV configuration table;

FIG. 26 shows an example of the configuration of an assignment management table;

FIG. 27 shows an example of the configuration of a pooled area management table;

FIG. 28 shows an example of the flow of HDEV creation processing;

FIG. 29 shows an example of the flow of processing carried out in the case of a host adapter 11 having received an I/O request from a host 4 in a third embodiment;

FIG. 30 shows an example of the flow of internal LDEV I/O processing in a third embodiment;

FIG. 31 shows an example of the flow of external LDEV I/O processing in a third embodiment;

FIG. 32 shows an example of the configuration of a VDEV configuration table in a fourth embodiment;

FIG. 33 is an explanatory drawing of a pointer for a journal LDEV;

FIG. 34 shows an example of journal reading processing;

FIG. 35 shows an example of journal copying processing;

FIG. 36 is an explanatory drawing of the concept of a first embodiment of the present invention;

FIG. 37A shows a backup device connected to a host in a fifth embodiment; and,

FIG. 37B shows an example of the flow of backup processing.

### DESCRIPTION OF THE PREFERRED EMBODIMENTS

The following provides an explanation of several embodiments of the present invention with reference to the drawings.

### First Embodiment

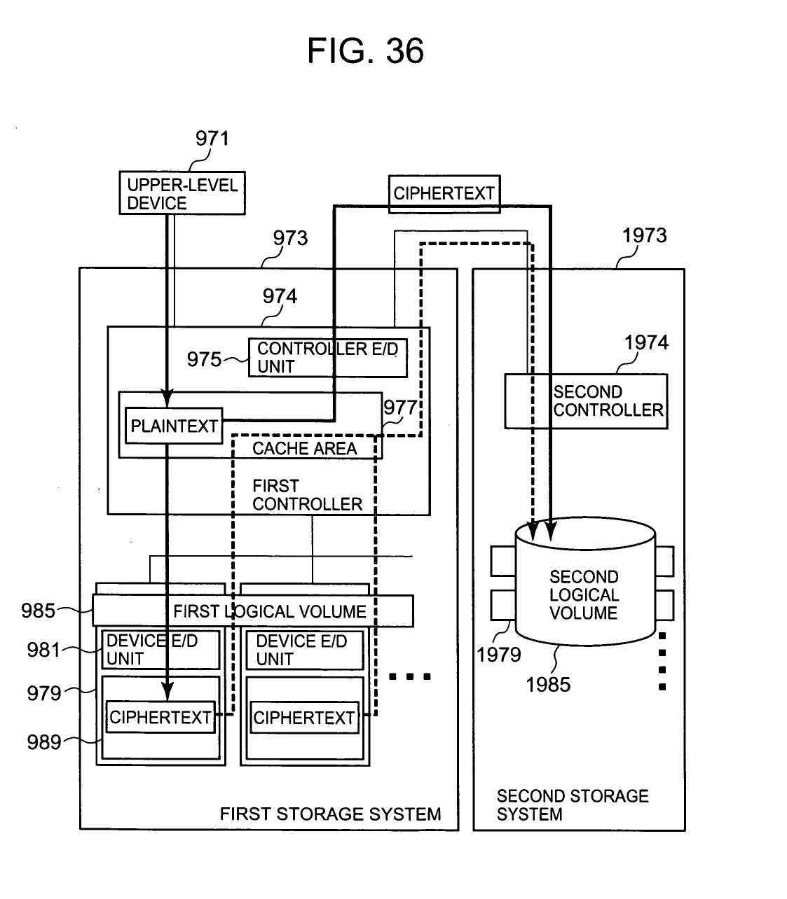

FIG. 36 is an explanatory drawing of the concept of a first embodiment of the present invention.

A first storage system 973 is communicably connected with a second storage system 1973. This second storage system 1973 is provided with a plurality of second storage devices 1979, a second logical volume 1985 is prepared on the basis of the plurality of second storage devices 1979, and a second controller 1974. The second controller 1974 requests writing or reading of data to each of the second storage devices 1979 based on the second logical volume 1985 by processing an access request (write request/read request) to the second logical volume 1985. As a result, data can be read out from or written to each second storage device 1979.

The first storage system 973 is provided with a plurality of first storage devices 979, a first logical volume 985 is prepared on the basis of the plurality of first storage devices 979, and a first controller 974.

A device encryption/decryption processing unit (this processing is abbreviated as “encryption/decryption”, and this unit is abbreviated as a “device E/D unit”) 981 is contained in each of the first storage devices 979. Data (plaintext to be described later) received with a write request by a first storage device 979 is written to a storage medium 989 of the first storage device 979 after being encrypted by the device E/D unit 981. In addition, data (ciphertext to be described later)read from the storage medium 989 in accordance with a read request received by a first storage device 979 is sent to the first controller 974 from the first storage device 979 after being decrypted by the device E/D unit 981.

The first controller 974 has a cache area 977, and a controller encryption/decryption processing unit (to be abbreviated as the “controller E/D unit”) 975. The first controller 974 receives and processes write requests from an upper-level device 971. In the following explanation, write data with the write request is referred to as “plaintext”. Although this write data may be subjected to some form of encryption processing in a specific layer of the upper-level device 971 (for example, an application program or operating system), it is referred to as “plaintext” in the sense that it is still not encrypted after having been received from the first storage system 973. In contrast, once that plaintext has been encrypted in the first storage system 973, it is referred to as “ciphertext”.

The first controller 974 temporarily stores plaintext accompanying a write request received from the upper-level device 971 in the cache area 977. This first controller 974 judges whether a writing destination in the case of having processed that write request is the first logical volume 985 or the second logical volume 1985.

If the first controller 974 has judged the writing destination to be the first logical volume 985, it transmits the plaintext in the cache area 977 to a first storage device 979 serving as the basis of the first logical volume 985 without encrypting in the controller E/D unit 975. As a result, the plaintext received by the first storage device 979 becomes, ciphertext as a result of being encrypted by the device E/D unit 981 of the first storage device 979, and the ciphertext is written to the storage medium 989 of the first storage device 979.

On the other hand, if the first controller 974 has judged the writing destination to be the second logical volume 1985, the plaintext in the cache area 977 is encrypted in the controller E/D unit 975 (in other words, transformed from plaintext to ciphertext), and a write request designating the second logical volume 1985 along with the ciphertext is transmitted to the second storage system 1973. As a result, the ciphertext is written to a second storage device 1979 serving as the basis of the second logical volume 1985 designated by the write request as a result of the write request being processed by the second controller 1974.

According to the above-mentioned processing, the encryption processing workload attributable to the first controller 974 can be reduced as much as possible.

The first controller 974 forms a volume pair with the first logical volume 985 and the second logical volume 1985, and is able to copy a stored ciphertext in the first logical volume 985 to the second logical volume 1985. More specifically, the first controller 974 reads data (ciphertext) from each first storage device 979 without encrypting in device E/D unit 981 of each first storage device 979 serving as the basis of the first logical volume 985, and temporarily stores it in the cache area 977. The first controller 974 then copies the ciphertext in the cache area 977 to the second logical volume 1985 without encrypting in the controller E/D unit 975. As a result, the encryption overhead attributable to the first controller 974 can be reduced. Furthermore, reading of ciphertext from a first storage device 979 and storage of the ciphertext in the second logical control volume 1985 may also be carried out primarily by the second controller 1974.

The above explanation encompasses a summary of the first embodiment. Furthermore, the encrypting sections and decrypting sections of the above-mentioned E/D units 975 and 981 may also be physically separated. The E/D units 975 and 981 can be in the form of engines realized by hardware (such as a large scale integration (LSI) circuit), computer program, or a combination thereof.

The following provides a detailed explanation of the first embodiment. Furthermore, in the following explanation, the E/D units are in the form of hardware. In addition, in the following explanation, the first storage devices and the second storage devices are in the form of hard disk drives (HDD), and for this reason, the storage medium is a hard disk. However, none of the storage devices are limited to a HDD, but rather other storage devices such as a digital versatile disk (DVD) drive, magnetic tape drive or flash memory device and so on can also be employed. Consequently, the storage medium is also not limited to a hard disk, but rather other types of storage media such as a DVD, magnetic tape or flash memory and so on can also be employed.

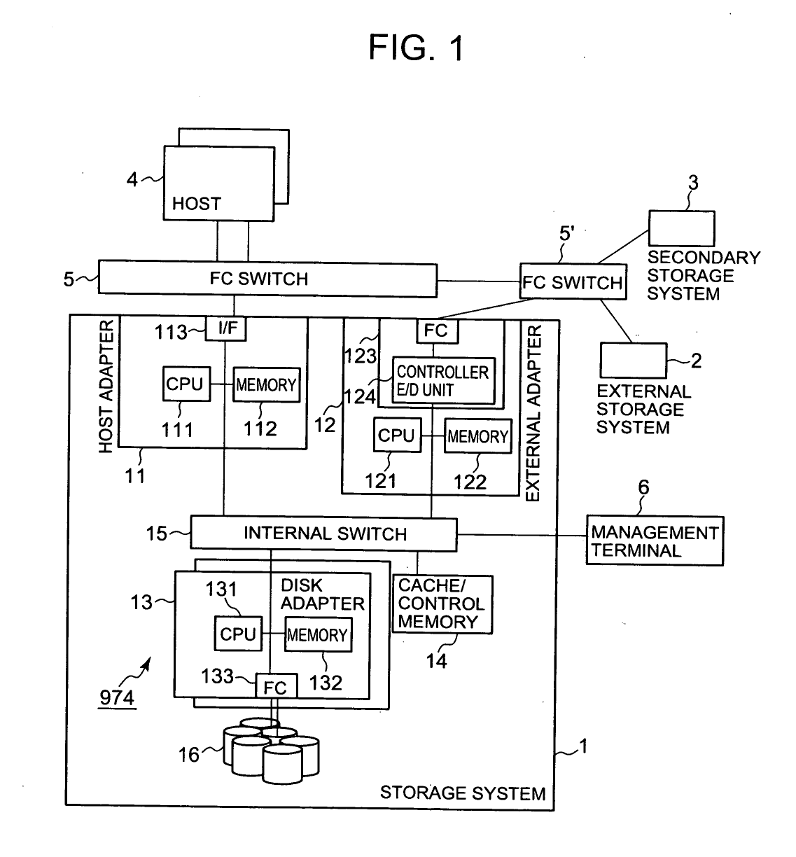

FIG. 1 shows an example of the physical configuration of a computer system as claimed in a first embodiment of the present invention.

A storage area network (SAN) is constructed by a plurality of fibre channel (FC) switches 5 and 5′. A plurality (or one) of host computers (to be abbreviated as “hosts”) 4, a host adapter 11 of a storage system 1, and an FC switch 5═ are connected to an FC switch 5. An external adapter 12 of the storage system 1, a secondary storage system 3, and an external storage system 2 are connected to the FC switch 5′. The secondary system 3 and the external storage system 2 are each a type of second storage system 1973.

The storage system 1 can be in the form of, for example, a redundant array of independent (or inexpensive) disks (RAID) provided with a large number of HDDs 16 arranged in the form of an array. However, the storage system 1 is not limited thereto, but rather can also be configured in the form of a switch comprising a communication network such as a highly functional, intelligent fibre channel switch.

The storage system 1 has a controller 974 connected to the plurality of HDDs 16. The functions of the controller 974 contained in the FC switch 5, and as such, the storage system 1 may also be realized by combining the FC switch 5 and the plurality of HDDs 16. The controller 974 is provided with, for example, a plurality of channel adapters (abbreviated as “CHA”) 11 and 12, a plurality of disk adapters (abbreviated as “DKA”) 13, a cache/control memory 14, and an internal switch 15.

The CHA 11 and 12 have one or a plurality of I/F (such as a communication port or a communication control circuit provided with a communication port) 113 and 123 communicably connected to external devices (such as host computers or other storage systems), and carry out data communication with the external devices. In the present embodiment, the CHA 11 is referred to as a “host adapter” since it is an adapter which communicates with the host computers 4. The CHA 12 is referred to as an “external adapter” since it is an adapter which communicates with storage systems present in an external system such as the external storage system 2 or the secondary storage system 3. The host adapter 11 and the external adapter 12 are composed in the form of a microcomputer system (such as a circuit board) provided with CPU 111 and 121, memory 112 and 122 and so on. The host adapter 11 and the external adapter 12 may also be integrated into a single unit.

A controller E/D unit 124, which encrypts and decrypts data input to the external adapter 12, is provided in the I/F 123 of this external adapter 12. The controller E/D unit 124 is composed so as to, for example, encrypt data input from inside the storage system 1 (such as the internal switch 15), and decrypt data input from outside the storage system 1 (such as the FC switch 5′).

The host adapter 11 may also be configured with the same hardware as the external adapter 12. In this case, by setting the host adapter 11 so as not to encrypt and decrypt data input and output to and from the host adapter 11 (by, for example, setting a prescribed flag in the memory 112 or the controller E/D unit), data input and output to and from the host adapter 11 can be made not to be encrypted and decrypted in the controller E/D unit of the host adapter 11.

The DKA 13 have communication ports (such as FC ports) 133 for connecting to each HDD 16, and are able to communicate with the HDD 16 via these communication ports 133. The DKA 13 is composed in the form of a microcomputer system (such as a circuit board) provided with a CPU 131, memory 132 and so on. DKA 22 are able to write data written from the CHA 11 and 12 to a cache area of the cache/control memory 14 to the HDD 16, or write data that is read from the HDD 16 to a cache area.

The cache/control memory 14 is, for example, volatile or non-volatile memory. The cache/control memory 14 is memory having a cache area and a control area. It can be separated into memory having a cache area and memory having a control area. Data received from an external device (such as the host 4 or external storage system 2) or data read from the HDD 16 is temporarily stored in the cache area. Data relating to control in the storage system 1 (to be referred to as “control data”) is stored in the control area. Examples of the control data include each of the tables to be described later.

The internal switch 15 is, for example, a crossbar switch, and mutually connects the CHA 11 and 12, the DKA 13 and the cache/control memory 14. Other types of connectors such as a bus may be employed instead of the internal switch 15.

A management terminal 6, for example, is connected to the internal switch 15. This management terminal 6 is a computer for managing the storage system 1. The management terminal 6 can, for example, store various tables to be described later in a control area of the cache/control memory 14. Furthermore, a function carried out by the management terminal 6 may be also be contained in the host 4. Namely, the various tables to be described later may also be stored in the host 4.

The above has provided an explanation of an example of the physical configuration of a computer system as claimed in a first embodiment of the present invention. This is merely an example, and there is no need to limit the configuration of this computer system. For example, the controller 974 may employ a simpler configuration provided with a CPU and memory in a single circuit board.

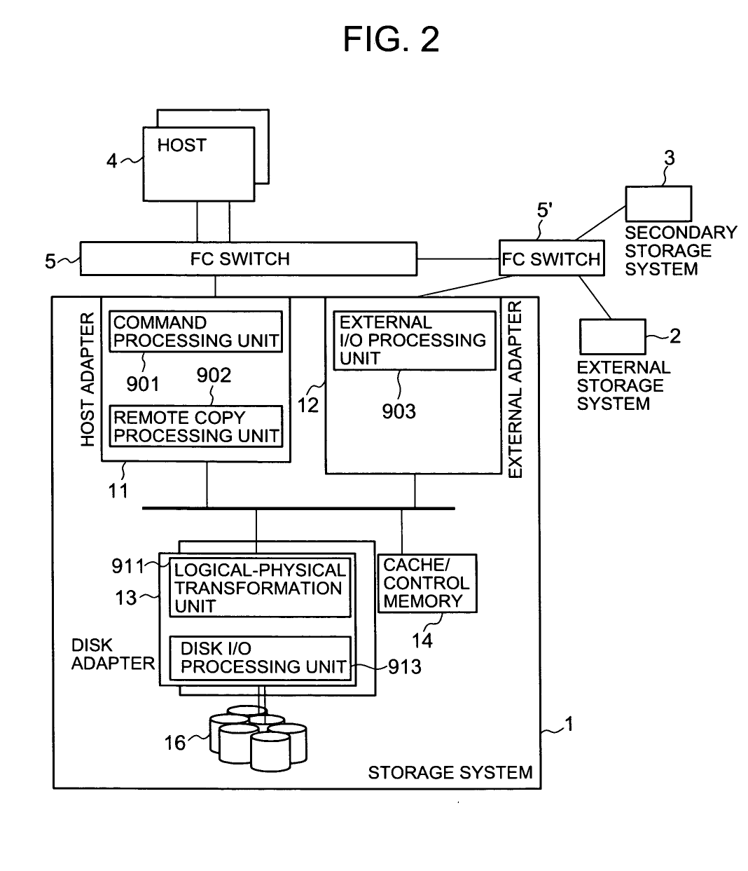

FIG. 2 shows an example of the logical configuration of a computer system as claimed in the first embodiment of the present invention.

The host adapter 11 has, for example, a command processing unit 901 and a remote copy processing unit 902 in the form of computer programs run by the CPU 111. The external adapter 12 has, for example, an external I/O processing unit 903 in the form of a computer program run by the CPU 121. The DKA 13 has, for example, a logical-physical transformation unit 911 and a disk I/O processing unit 913 in the form of a computer program run by the CPU 131. Hereinafter, when the above computer programs are mentioned as the subject of the process in the description of the processes, it means that processing is actually carried out by the CPU running these computer programs. A detailed description of the operation of each computer program will be subsequently described.

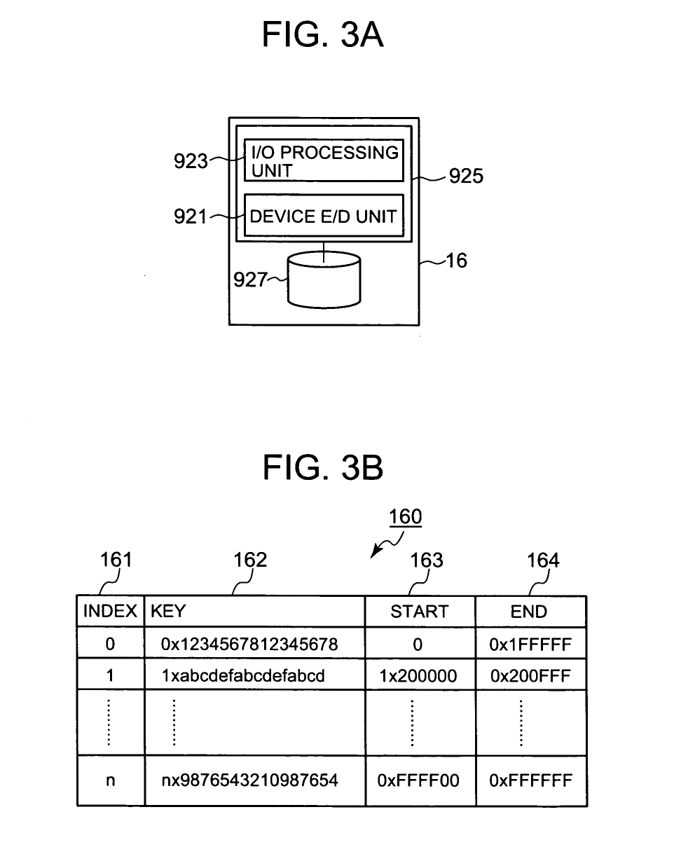

FIG. 3A shows an example of the configuration of an HDD 16.

The HDD 16 is provided with a hard disk 927 and an HDD controller 925 which controls writing and reading of data to and from the hard disk 927. The HDD controller 925 is provided with a device E/D unit 921 in addition to an I/O processing unit 923 for controlling writing and reading of data to and from the hard disk 927. In this embodiment, the I/O processing unit 923 can be in the form of a computer program run by a CPU not shown on the HDD controller 925. The device E/D unit 921 has an internal storage area (not shown), and a key management table 160 shown in FIG. 3B is stored in the storage area.

FIG. 3B shows an example of the configuration of the key management table 160.

This key management table 160 is a table for managing a plurality of storage regions (contiguous disk blocks in the hard disk 927 of the HDD 16 designated with two physical addresses such as logical block addresses (LBAs) in the SCSI protocol) and correlations between each of the storage regions and the corresponding encryption keys. More specifically, this table 160 has a column 161 in which index numbers are written, a column 162 in which electronic data in the form of encryption keys are written, a column 163 in which the starting address of a physical address range is written, and a column 164 in which the ending address of a physical address range is written.

The device E/D unit 921 is able to specify an encryption key corresponding to a physical address range containing the access destination of the hard disk 927 from this key management table 160 set in an internal storage area thereof. The device E/D unit 921 is able to encrypt data to be written to the access destination with a specified encryption key, or decrypt data read from the access destination with a specified encryption key.

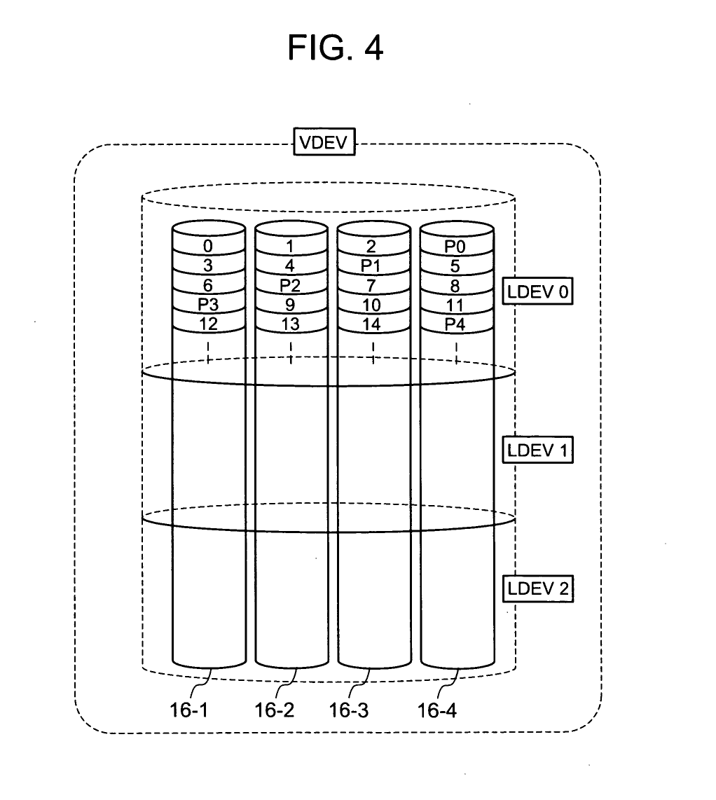

FIG. 4 shows an example of the correlation between the plurality of HDD 16 and a logical volume.

An RAID group is composed by a plurality (for example, four) of HDDs 16-1, 16-2, 16-3 and 16-4. In this example, three types of data are stored in three HDDs 16, and a parity data generated based on these three types of data is stored in the other HDD 16.

The storage area provided by this RAID group (consisting of an aggregation of the storage area of each HDD 16) is referred to as virtual device (abbreviated as VDEV) in the present embodiment. Each portion of the plurality of VDEV obtained by dividing this VDEV is a logical volume as referred to in the present embodiment. The logical volume is designated from the host 4, and also distinguished within the storage system 1. Therefore, a logical volume designated by the host 4 may be referred to as a logical unit (LU), and a logical volume distinguished within the storage system 1 may be referred to as a logical device (LDEV). In the example shown in this figure, although three LDEV are formed from a single VDEV, the number of LDEV may be more or less than this number (for example, a single LDEV for a single VDEV).

In the present embodiment, each LDEV is composed of four storage areas within the same physical address ranges of the HDD 16-1 to 16-4, respectively. Consequently, in the case of, for example, a single encryption key being mapped to each LDEV, the physical address range corresponding to the LDEV and the encryption key corresponding to the LDEV are set in each key management table 160 of the four HDD 16-1 to 16-4. In this example of FIG. 4, since there are three LDEV, three sets of physical address ranges and encryption keys are registered in each key management table 160. In the case of a plurality of encryption keys being mapped to a single LDEV, the number of those sets becomes greater than three.

In the present embodiment, there exists the cases in which the writing destination and reading source of data are outside the storage system 1. One case is that the writing destination and reading source are an external storage system 2 using an external connection by an external storage connection, and another case is that the writing destination and reading source are a secondary storage system 3 using remote copying.

The “external storage connection” as referred to in the present embodiment refers to technology in which the controller 974 provides a storage resource having the external storage system 2 to host 4 in the form of a storage resource of the storage system 1. The external storage connection explained below is only an example thereof, and other types of external storage connections, such as the technology disclosed in Japanese Patent Application Laid-open No. 2005-107645 (U.S. patent application Ser. No. 10/769805 and U.S. patent application Ser. No. 11/471556), can also be employed.

The “remote copying” as referred to in the present embodiment refers to a technology for composing a volume pair with a first logical volume within the storage system 1 and a second logical volume within the secondary storage system 3, and copying data stored in the first logical volume to the second logical volume. The remote copying explained below is also only an example thereof, and other remote copying technologies may also be employed.

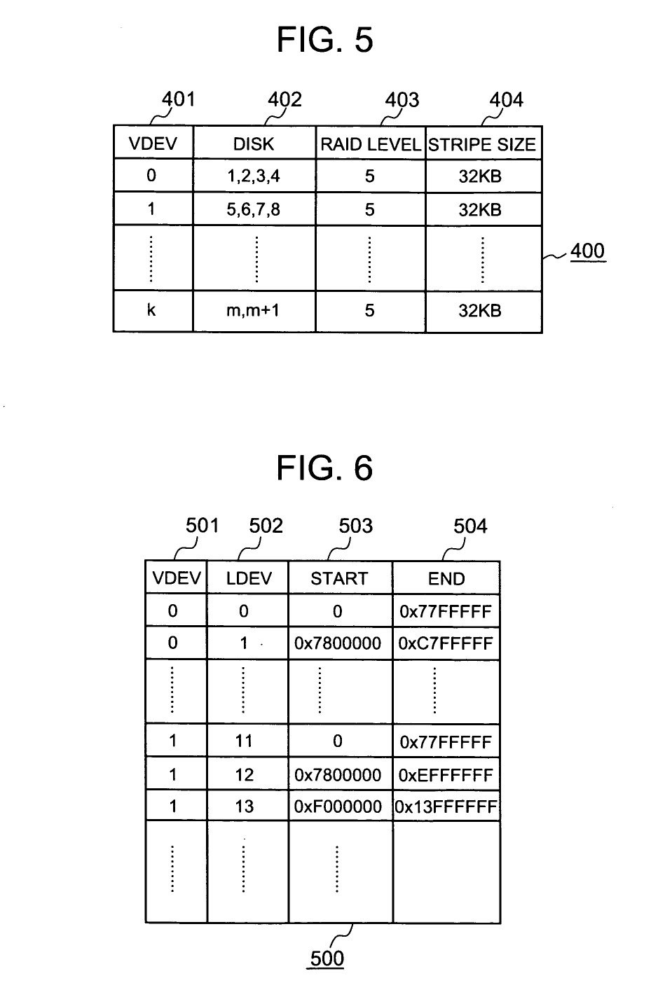

The following provides an explanation of various tables contained in control data stored in the cache/control memory 14 with reference to FIGS. 5 to 9.

FIG. 5 shows an example of the configuration of an RAID configuration table.

A RAID configuration table 400 is a table for managing RAID configuration of each VDEV. More specifically, this table 400 has, for example, a column 401 in which VDEV identification numbers are written, a column 402 in which HDD identification numbers are written, a column 403 in which RAID levels are written, and a column 404 in which stripe sizes are written. Namely, a VDEV identification number, a plurality of HDD identification numbers comprising each VDEV, the RAID level of the VDEV, and the stripe size are written for each VDEV in this table 400.

FIG. 6 shows an example of the configuration of a VDEV configuration table.

A VDEV configuration table 500 is a table for managing VDEV configuration. More specifically, this table 500 has, for example, a column 501 in which VDEV identification numbers are written, a column 502 in which LDEV identification numbers are written, a column 503 in which the starting address of a VDEV logical address range of an LDEV is written, and a column 504 in which the ending address of a VDEV logical address range of an LDEV is written. Namely, the identification numbers of a specific LDEV within a specific logical address range of a specific VDEV are written in this table 500.

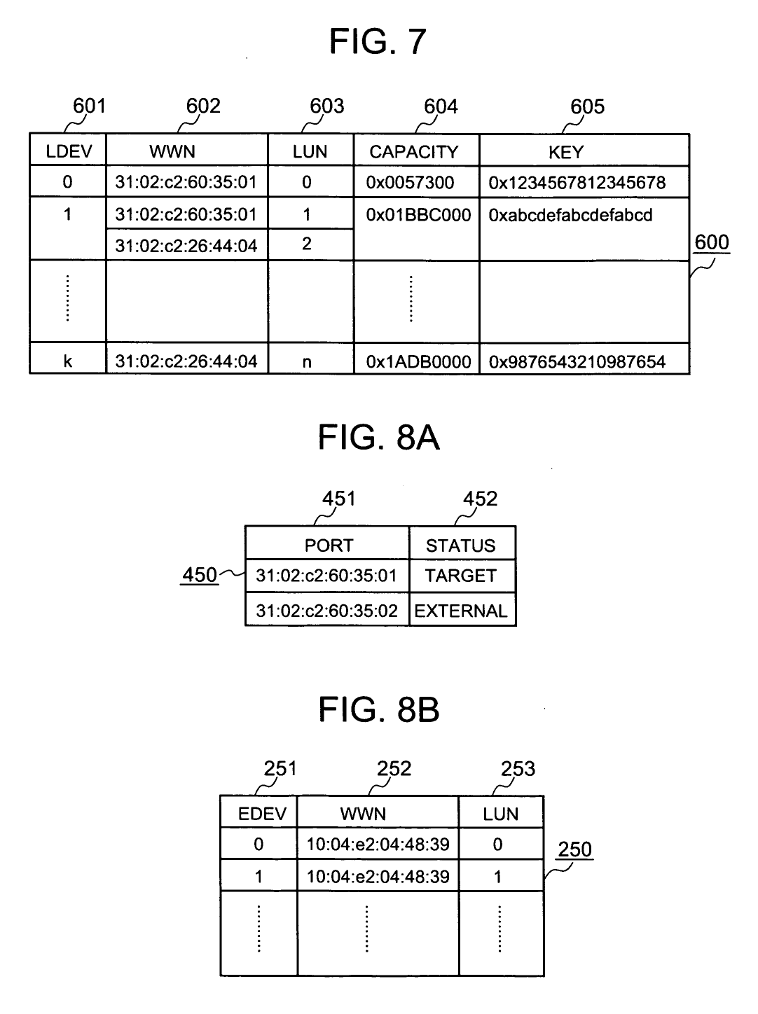

FIG. 7 shows an example of the configuration of an LU configuration table.

An LU configuration table 600 is a table for managing the configuration of each LU. More specifically, this table 600 has, for example, a column 601 in which LDEV identification numbers are written, a column 602 in which world wide names (WWN) are written, a column 603 in which logical unit numbers (LUN) are written, a column 604 in which LDEV storage capacities are written, and a column 605 in which encryption keys are written. Namely, an LDEV identification number, WWN and LUN mapped to the LDEV, the storage capacity of that LDEV, and the encryption key mapped to that LDEV are written in this table 600 for each LU.

In this embodiment, a logical volume designated from the host 4 is referred to as an “LU” as described above. More specifically, however, a logical volume mapped by a WWN and LUN by, for example, a fibre channel protocol, is referred to as an “LU”. Furthermore, the WWN and LUN columns 602 and 603 need not be provided in, for example, a mainframe.

FIG. 8A shows an example of the configuration of a port configuration table.

A port configuration table 450 is a table for managing the configuration of the communication ports of each I/F 113 and 123. More specifically, this table 450 has, for example, a column 451 in which communication port identifiers (for example, WWN) are written, and a column 452 in which communication port status is written. A “target” status represents a communication port in the I/F 113 of the host adapter 11, while an “external” status represents a communication port in the I/F 123 of the external adapter 12. A plurality of I/Fs 113 and 123 may exist for a single adapter 11 or 12. In addition, a plurality of communication ports may exist for a single I/F 113 or 123.

In addition, in the case a controller E/D unit is present in the I/F 113 of the host adapter 11, if the status of a communication port of that I/F 113 is “target”, encryption and decryption can be prevented from being carried out on the controller E/D unit. For example, by setting a flag for prohibiting execution of encryption and decryption in the storage area of the controller E/D unit, encryption and decryption can be prevented from being carried out on the controller E/D unit.

FIG. 8B shows an example of the configuration of an EDEV data table.

An EDEV data table 250 is a table for managing data relating to each EDEV. More specifically, this table 250 has, for example, a column 251 in which EDEV identification numbers are written, and columns 252 and 253 in which WWN and LUN mapped to an EDEV are respectively written.

Here, EDEV is the abbreviation for “external device”, and refers to storage space provided by one or a plurality of HDD present in the external storage system 2. More specifically, the EDEV refers to a VDEV present in the external storage system 2. In the present embodiment, since the WWN and LUN are mapped, the EDEV is a virtual LU not prepared on the basis of the HDD 16 in the storage system 1.

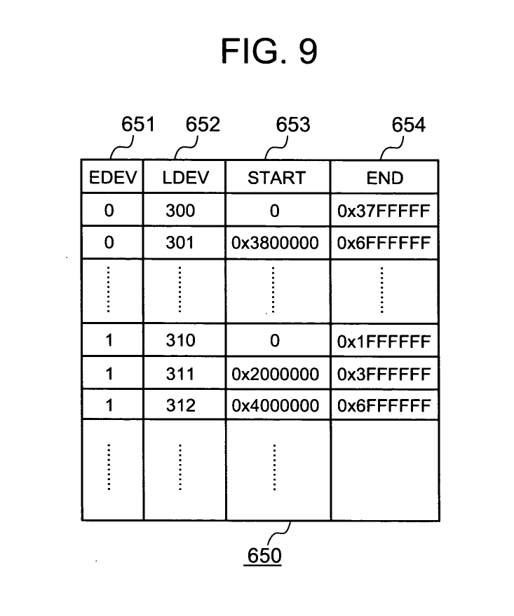

FIG. 9 shows an example of the configuration of an EDEV configuration table.

An EDEV configuration table 650 is a table for managing EDEV configuration. More specifically, this table 650 has, for example, a column 651 in which EDEV identification numbers are written, a column 652 in which LDEV identification numbers are written, a column 653 in which the starting address in an EDEV logical address range of an LDEV is written, and a column 654 in which the ending address in an EDEV logical address range of an LDEV is written. Namely, the identification numbers of a specific LDEV within a specific logical address range of a specific EDEV are written in this table 650. In the following explanation, an LDEV within an EDEV is referred to as an “external LDEV”, while an LDEV within a VDEV is referred to as an “internal LDEV” to distinguish LDEV within EDEV and LDEV within VDEV.

Different numbers are used for the identification numbers of external LDEV and the identification numbers of internal LDEV, respectively. The command processing unit 901 is able to identify internal LDEV and external LDEV by referring to the HDEV configuration table 500 and the EDEV configuration table 650.

The above has provided an explanation of the various types of tables. The following provides an explanation of the various processing flows carried out in the present embodiment.

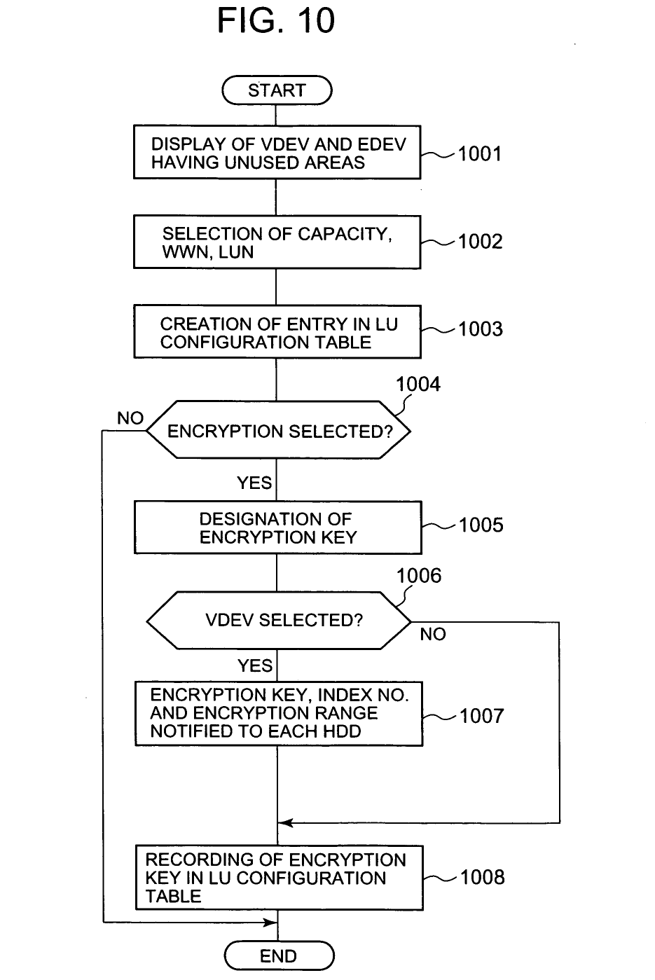

FIG. 10 shows an example of the flow of LDEV creation processing. Furthermore, in this drawing, numbers may be abbreviated with a pound (#) sign (to apply similarly to other drawings as well).

A storage resource of the management terminal 6 stores data relating to the various configurations of the storage system 1 and the external storage system 2 (including, for example, unused HDD numbers, total available HDD storage capacity in a subsystem, and available capacity of VDEV and EDEV).

In step 1001, a predetermined computer program run by a CPU of the management terminal 6 (to be referred to as a management program) displays VDEV and EDEV having unused areas (available capacity) on a display screen of the management terminal 6. Alternatively, the management program may also receive instructions from an administrator to construct new VDEV and/or EDEV having a capacity equal to or less than the total available HDD storage capacity.

In step 1002, the management program receives selection of a VDEV or EDEV, and designation of capacity, WWN and LUN.

In step 1003, an entry of a newly created LDEV (hereinafter to be referred to as a “target LDEV” in this explanation of FIG. 10) is created in the LU configuration table 600. More specifically, the management program transmits, for example, the identification number, capacity, WWN and LUN of a selected VDEV or EDVE along with a setting command. A predetermined computer program run by a CPU in the storage system 1 (hereinafter to be referred to as a “table construction program” for the sake of convenience) sets the capacity, WWN and LUN in the LU configuration table 600 in accordance with the setting command. The LDEV number (LDEV identification number) desired by an administrator or one of the unused LDEV numbers, for example, is then written by the administrator or automatically to a cell corresponding to an LDEV number in a row containing entry in which the capacity, WWN and LUN are set. The LDEV number written here is the LDEV number of an internal LDEV or an external LDEV.

In step 1004, the management program and/or the table construction program judge whether or not encryption is to be selected for the target LDEV (for example, whether or not the target LDEV is to be encrypted is received from the administrator). In the case encryption has been selected, the processing flow proceeds to step 1005, while in the case non-encryption has been selected, the processing flow ends.

In step 1005, an encryption key is designated. Here, the designated encryption key may be an encryption key received by the management program from the administrator, or an encryption key determined by carrying out a predetermined calculation by the table construction program.

In step 1006, the table construction program judges whether the logical devices selected by the administrator is a VDEV or an EDEV. This can be carried out by, for example, acquiring the identification number of a selected VDEV or EDEV from the above-mentioned notification from the management program, and judging which of the VDEV configuration table 500 or the EDEV configuration table 650 the identification number is present. In the case of having been judged to be a VDEV, the processing flow proceeds to step 1007, while in the case of having been judged to be an EDEV, the processing flow proceeds to step 1008.

In step 1007, the table construction program determines the logical address range of the target LDEV in the selected VDEV (for example, the first LBA and last LBA in the VDEV) based on the available area of the VDEV and the capacity of the target LDEV. The table construction program then notifies the disk I/O processing unit 913 of the DKA 13 connected to each HDD 16 (HDD 16 specified from the VDEV configuration table 500) composing the VDEV of the determined logical range and the designated encryption key. The disk I/O processing unit 913 than transforms the notified logical address range to a physical address range of each HDD 16 in the logical-physical transformation unit 911. The disk I/O processing unit 913 then transmits the resulting physical address range (encryption range), the notified encryption key, and the index number (for example, an index number determined by the disk I/O processing unit 913) to each HDD 16. As a result, the I/O processing unit 923 of each HDD 16 registers the received index number, physical address range and encryption key in the key management table 160. Furthermore, the disk I/O processing unit 913 stores the physical address range and index number in the memory 132 of the DKA 13, and in the case of transmitting a data read request to an HDD 16, by designating an index number corresponding to the physical address range containing the read source physical address, decryption using an encryption key corresponding to the specific index number may also be carried out. In addition, the “encryption range” refers to a physical address range requiring encryption among the entire physical address range of the hard disk 927 of the HDD 16, or in other words, the physical address range set in the key management table 160.

In step 1008, the table construction program registers the encryption key designated in step 1005 to a cell corresponding to the target LDEV in the LU configuration table 600.

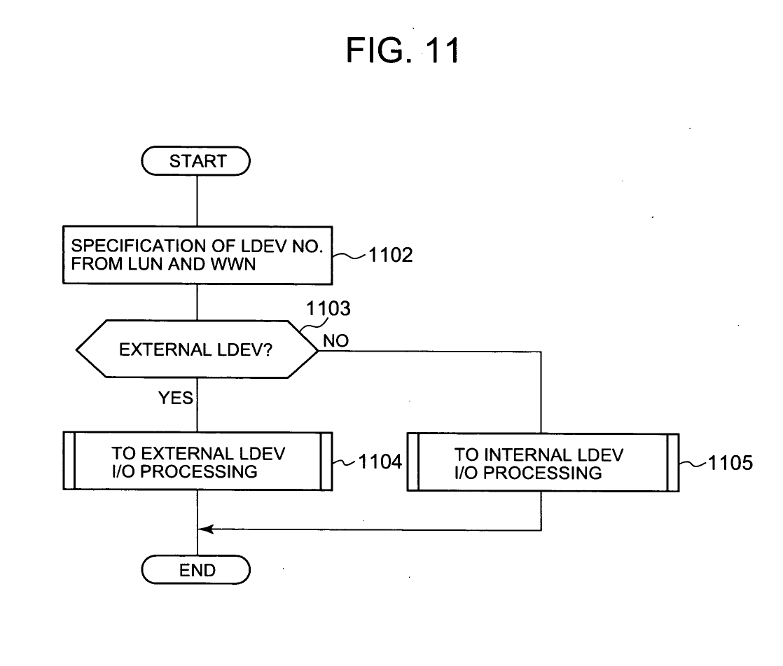

FIG. 11 shows an example of the flow of processing carried out in the case of the host adapter 11 having received an I/O request from the host 4.

In step 1102, the command processing unit 901 specifies an LDEV number corresponding to an LUN and WWN designated in an I/O request (write request or read request) from the host 4. If the LUN and WWN correspond to an internal LDEV, the LDEV number can be specified from the HDEV configuration table 500 (see FIG. 6). On the other hand, if the LUN and WWN correspond to an EDEV, the EDEV is specified from the EDEV data table 250 (see FIG. 8) and designated with the received I/O request. The LDEV number of the external LDEV containing an LBA as a logical address range can be specified from the EDEV configuration table 650 (see FIG. 9) based on the LBA in the specified EDEV.

In step 1103, the command processing unit 901 judges whether the LDEV corresponding to the specified LDEV number is an external LDEV or internal LDEV. If it is an external LDEV (YES in step 1003), the processing flow proceeds to step 1104 and as a result thereof, external LDEV I/O processing is carried out. On the other hand, if it is an internal LDEV (NO in step 1103), then the processing flow proceeds to step 1105 and as a result thereof, internal LDEV I/O processing is carried out.

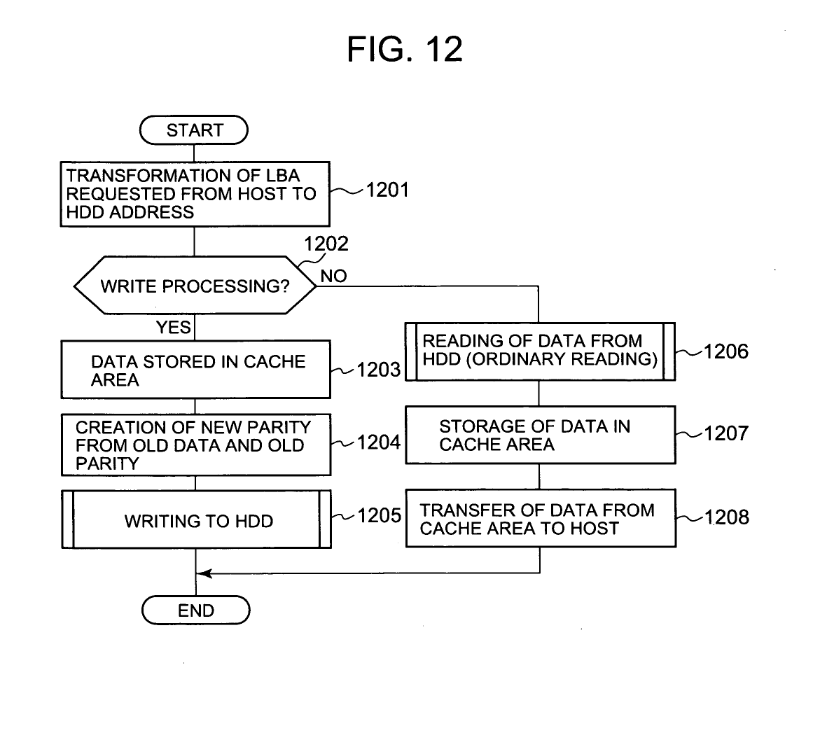

FIG. 12 shows an example of the flow of internal LDEV I/O processing. This example describes the case of the internal LDEV being contained in a VDEV of a RAID 5. In the explanation of FIG. 12, the internal LDEV is referred to as a “target internal LDEV”, each HDD belonging to the VDEV is referred to as a “target HDD”, and a physical address calculated from an LBA designated with an I/O request from the host 4 (address in an HDD) is referred to as a “target physical address”.

In step 1201, an LBA designated with an I/O request from the host 4 is transformed to a target physical address. More specifically, the command processing unit 901, for example, sends out an I/O request containing the LBA designated with the I/O request from the host 4 to the DKA 13, and the disk I/O processing unit 913 receives that I/O request. That request may be written to a control area of the cache/control memory 14, or may be transmitted to the DKA 13. That DKA 13 is the DKA 13 connected to each target HDD 16. The disk I/O processing unit 913 of the DAK 13 has the logical-physical transformation unit 911 transform the LBA in the received I/O request to the target physical address.

In step 1202, the command processing unit 901 judges whether the received I/O processing is a write request or a read request. In the case of being a write request, the processing flow proceeds to step 1203, while in the case of being a read request, the processing flow proceeds to step 1206. Furthermore, this step 1202 may be completed prior to completion of the step 1201.

In step 1203, the command processing unit 901 stores plaintext (write data) according to a write request from the host 4 in a cache area of the cache/control memory 14.

In step 1204, the disk I/O processing unit 913 generates a new parity based on the data and parity acquired from the target internal LDEV (old data and old parity) and the plaintext of the cache area (new data).

In step 1205, the disk I/O processing unit 913 writes the new data and the new parity by transmitting a write request for the new data and the new parity designating the target physical address to each target HDD 16.

In step 1206, the disk I/O processing unit 913 transmits an ordinary read request designating the target physical address to each target HDD 16. As a result, data is read from each target HDD 16 after being transformed from ciphertext to plaintext.

In step 1207, the disk I/O processing unit 913 stores the read data (plaintext) in the cache area.

In step 1208, the command processing unit 901 transmits the data stored in the cache area to the host 4 (transmission origin of the read request received-in-step 1102 of FIG. 11).

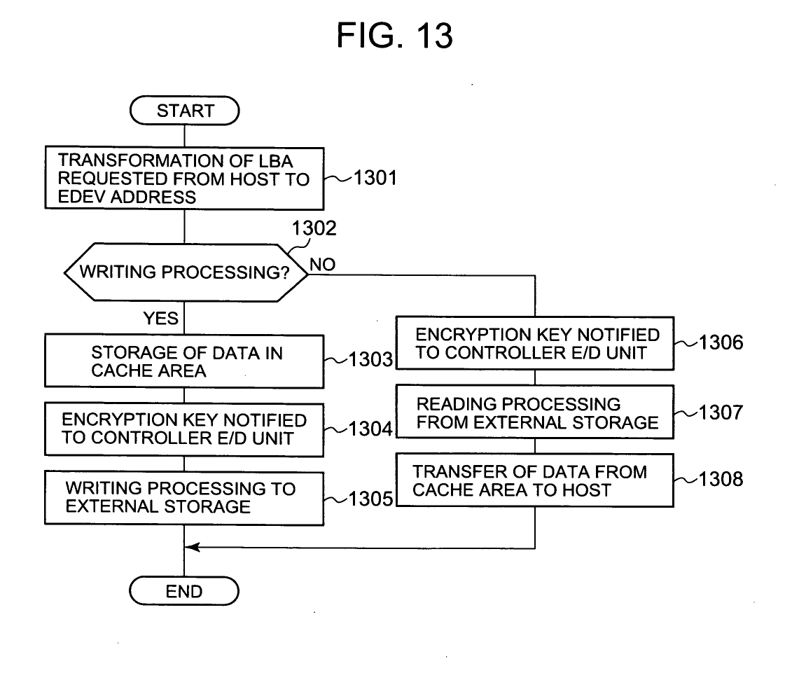

FIG. 13 shows an example of the flow of external LDEV I/O processing. In this explanation of FIG. 13, the target LDEV serving as the access destination is referred to as a “target external LDEV”, the EDEV containing the target external LDEV is referred to as a “target EDEV”, and the address in the target EDEV calculated from the LBA designated with an I/O request from the host 4 is referred to as a “target EDEV address”.

In step 1301, the LBA designated with the I/O request from the host 4 is transformed to a target EDEV address. More specifically, the command processing unit 901, for example, determines the LUN, WWN and LBA designated with the I/O request made to the external storage system 2 in the form of a target EDEV address based on the LUN, WWN and LBA designated with the I/O request from the host 4. This address transformation can be carried out using a method disclosed in, for example, the previously described Japanese Patent Application Laid-open No. 2005-107645 (U.S. patent application Ser. No. 10/769805 and U.S. patent application Ser. No. 11/471556).

In step 1302, the command processing unit 901 judges whether the received I/O processing is a write request or a read request. In the case of being a write request, the processing flow proceeds to step 1303, while in the case of being a read request, the processing flow proceeds to step 1306.

In step 1303, the command processing unit 901 stores plaintext (write data) in a cache area of the cache/control memory 14 in accordance with a write request from the host 4.

In step 1304, the command processing unit 901 specifies an encryption key corresponding to the target external LDEV from the LU configuration table 600, and notifies the controller E/D unit 124 of the external adapter 12 of the specified encryption key. As a result, the encryption key is set in the controller E/D unit 124.

In step 1305, the plaintext stored in the cache area is transformed to a ciphertext by the controller E/D unit 124, and the ciphertext is stored in the external storage system 2. More specifically, the command processing unit 901, for example, instructs the external I/O processing unit 903 to issue a write request to the external storage system 2 together with a target EDEV address. The external I/O processing unit 903 then reads the plaintext from the cache area and issues a write request for the read plaintext designating the target EDEV address. This write request is transmitted to the external storage system 2 after passing through the controller E/D unit 124. The controller E/D unit 124, for example, is composed so as to encrypt and decrypt data portions of I/O requests, and for this reason, the target EDEV address that is contained in the write request is not encrypted, while the plaintext in the form of the data portion is encrypted and output.

In step 1306, the same processing as the step 1304 is carried out.

In step 1307, data is read from the external storage system 2. More specifically, the command processing unit 901, for example, instructs the external I/O processing unit 903 to issue a read request to the external storage system 2 together with a target EDEV address. The external I/O processing unit 903 then issues a read request designating the target EDEV address. In response to that read request, the I/F 123 of the external adapter 12 receives ciphertext from the external storage system 2, and this ciphertext is decrypted using the above-mentioned set encryption key by the controller E/D unit 124. As a result, the received ciphertext is transformed to plaintext. The external I/O processing unit 903 stores the plaintext in the cache area.

In step 1308, the command processing unit 901 transmits the data (plaintext) in the cache area to the host 4.

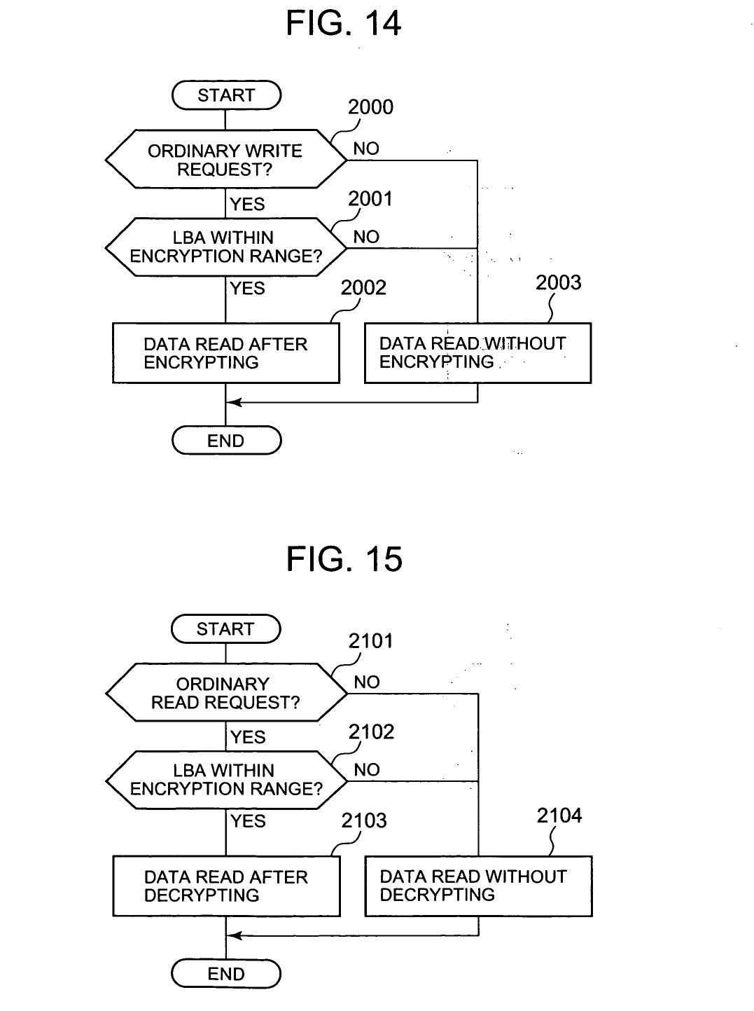

FIG. 14 shows an example of writing processing of an HDD 16.

In step 2000, the I/O processing unit 923 receives a write request designating a target physical address (LBA), and judges whether the write request is an ordinary write request or non-encryption write request. An ordinary write request refers to the request to write data after encryption, while a non-encryption write request refers to the request to write data without encrypting. Whether or not the write request is an ordinary write request or non-encryption write request can be judged by, for example, whether or not a flag indicating a non-encryption write request has been set at the location of a specific byte in the write request received from the DKA 13 (referred to as a write command descriptor block (CDB)). In this case, the disk I/O processing unit 913 is able to transmit the write request without setting a flag for that write request in the case of issuing an ordinary write request, or transmit the write request by setting the flag for the write request in the case of issuing a non-encryption write request. In the case the received write request is an ordinary write request, the processing flow proceeds to step 2001, while in the case the received write request is a non-encryption request, the processing flow proceeds to step 2003. In another embodiment, to judge whether the write request is an ordinary write request or non-encryption write request can be realized by judging whether or not the physical address range designated in the write request is registered in the key management table 160.

In step 2001, the I/O processing unit 923 receives the write request designating the target physical address and judges whether or not the target physical address falls within the encryption range by referring to the key management table 160 (see FIG. 3B) If the target physical address is within the encryption range, the processing flow proceeds to step 2002, while if it is outside the encryption range, the processing flow proceeds to step 2003.

In step 2002, the I/O processing unit 923 writes the data (plaintext) to the hard disk 927 of the device E/D unit 921. As a result, the plaintext is transformed to ciphertext by the device E/D unit 921 and written to the hard disk 927.

In step 2003, the I/O processing unit 923 writes the data to the hard disk 927 without encrypting in the device E/D unit 921. Examples of methods for preventing encryption include directing the data through the device E/D unit 921 after having set a flag indicating the absence of a need for encryption in the device E/D unit 921, and selecting a data transmission line which does not go through the device E/D unit 921 and writing the data to the hard disk 927 through the data transmission line. These methods can also be applied to methods for preventing decryption.

FIG. 15 shows an example of reading processing of an HDD 16.

In step 2101, the I/O processing unit 923 receives a read request designating a target physical address, and judges whether the read request is an ordinary read request or a non-decryption read request. An ordinary read request refers to requesting reading after decryption, while a non-decryption read request refers to requesting reading without decrypting. Whether or not the read request is an ordinary read request or non-decryption read request can be judged by, for example, whether or not a flag indicating a non-decryption read request has been set at a predetermined location in the read request. In this case, the disk I/O processing unit 913 is able to transmit the read request without setting a flag for that read request in the case of issuing an ordinary read request, or transmit the read request by setting the flag for the read request in the case of issuing a non-decryption read request. In the case the received read request is an ordinary read request, the processing flow proceeds to step 2102, while in the case the received read request is a non-decryption read request, the processing flow proceeds to step 2104.

In step 2102, the I/O processing unit 923 judges whether or not the target physical address (LBA) designated with an ordinary read request falls within the encryption range by referring to the key management table 160 (see FIG. 3B). If the target physical address is within the encryption range, the processing flow proceeds to step 2103, while if it is outside the encryption range, the processing flow proceeds to step 2104.

In step 2103, the I/O processing unit 923 reads the data from the hard disk 927 through the device E/D unit 921. As a result, the data transformed from ciphertext to plaintext by the device E/D unit 921 is acquired by the I/O processing unit 923. The I/O processing unit 923 then transmits the acquired plaintext to the disk I/O processing unit 913.

In step 2104, the I/O processing unit 923 reads the data from the hard disk 927 without decrypting the data with device E/D unit 921.

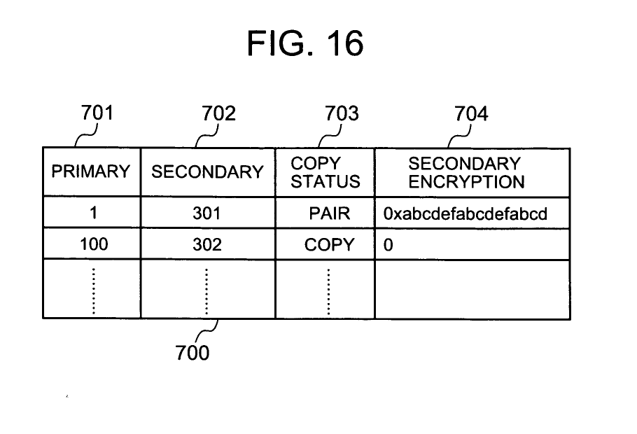

FIG. 16 shows an example of the configuration of a pair configuration table.

A pair configuration table 700 is contained in the control data stored in the cache/control memory 14, and is used for managing the configuration of volume pairs. The pair configuration table 700 has a column 701 in which LDEV numbers of primary LDEV are written, a column 702 in which LDEV numbers of secondary LDEV are written, a column 703 in which copy status is written, and a column 704 in which encryption keys of secondary LDEV are written. Namely, the LDEV numbers of LDEV serving as copy sources in the form of primary LDEV, the LDEV numbers of LDEV serving as copy destinations in the form of secondary LDEV, the copy status, and the encryption keys of the secondary LDEV are written in this table 700 for each volume pair.

Copy status indicates whether or not a primary LDEV and secondary LDEV are in a mirrored state. A mirrored state refers to all data in the primary LDEV being copied to the secondary LDEV. Namely, the primary LDEV and the secondary LDEV have the same status. A copy status of “pair” refers to the mirrored state. A copy status of “copy” refers to not being in the mirrored state, namely the state in which all of the data of the primary LDEV has been copied but has not been completely copied to the secondary LDEV.

In the present embodiment, in the case, for example, the table construction program has received an instruction to encrypt a secondary LDEV from an administrator, an encryption key of the primary LDEV corresponding to the secondary LDEV is acquired from the LU management table 600, and the acquired encryption key can be registered in a cell (area) corresponding to the secondary LDEV in the column 704 of the pair configuration table 700. At that time, if there is no encryption key corresponding to a primary LDEV, the table construction program may execute encryption key designation processing (for example, step 1005 of FIG. 10), and register the resulting encryption key in the above-mentioned cell.

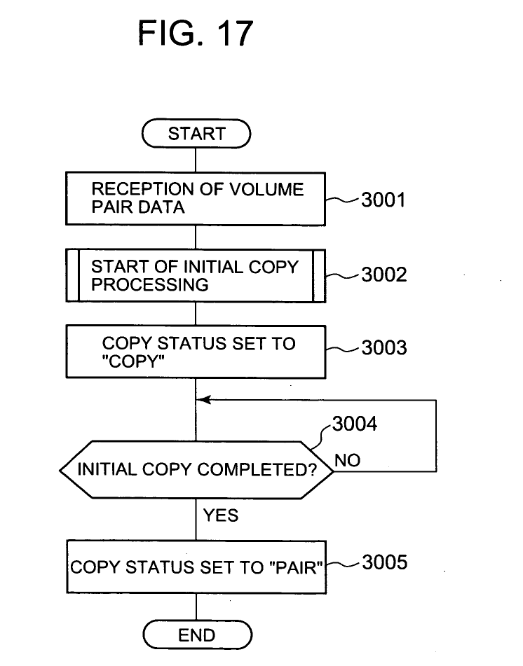

FIG. 17 shows an example of the flow of pair creation processing.

In step 3001, the table construction program run with the CPU of the storage system 1 receives data relating to a newly formed volume pair (to be referred to as a target volume) from the management program of the management terminal 6. More specifically, by, for example, the management program providing means for selecting one of the plurality of LDEVs in the storage system 1 and one of the plurality of LDEVs in the secondary storage system 3 via GUI (Graphical User Interface) based on data stored in a storage resource of the management terminal 6, the instruction to select a primary LDEV and a secondary LDEV is received, and data relating to each selected LDEV (for example, the LDEV number) is notified to the table construction program.

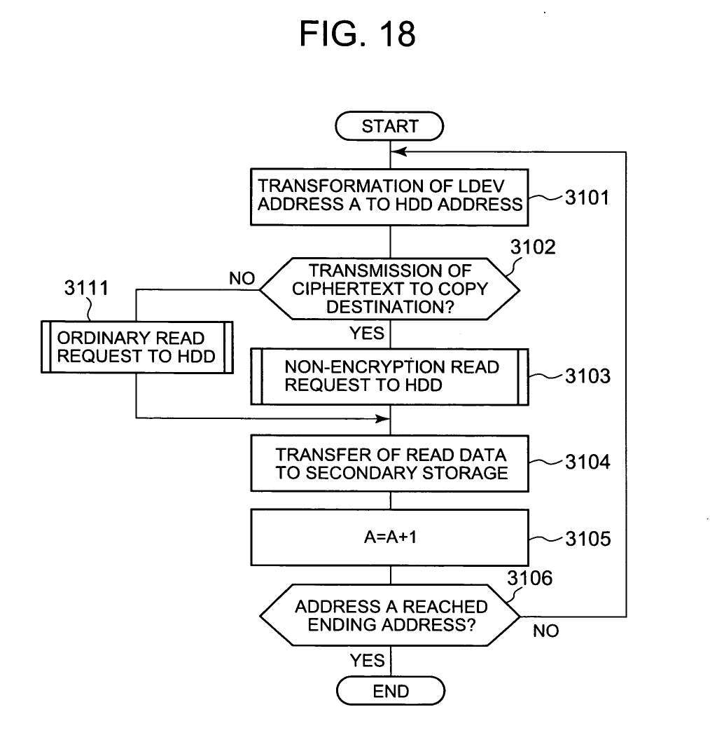

In step 3002, initial copy processing is started. This copy processing is begun by the table construction program to instruct the remote copy processing unit 902 to begin initial copy processing. This initial copy processing will be subsequently described in detail with reference to FIG. 18.

In step 3003, the table construction program sets the copy status of the target volume pair (entry in the pair configuration table 700) to “copy” following the start of initial copy processing.

In step 3004, the table construction program judges whether or not initial copy processing has been completed. If it has been completed, the processing flow proceeds to step 3005, and if it has not been completed, the processing flow returns to step 3004.

In step 3005, the table construction program sets the copy status of the target volume pair to “pair” following the start of initial copy processing.

FIG. 18 shows an example of the flow of initial copy processing. Furthermore, each HDD corresponding to a VDEV containing a primary LDEV is referred to as a “target HDD” in the subsequent explanation of this FIG. 18.

In this initial copy processing, copying is carried out sequentially from the starting address to the ending address of the primary LDEV.

More specifically, in step 3101, the remote copy processing unit 902 transforms an address A of the primary LDEV (for example, the starting address immediately after the start of initial copy processing) to a physical address (address in the target HDD) with the disk I/O processing unit 913.

In step 3102, the remote copy processing unit 902 judges whether ciphertext or plaintext is to be transmitted to the copy destination. This judgment can be made by, for example, judging whether or not an encryption key is mapped to a secondary LDEV in the pair configuration table 700. Furthermore, once this judgment is made by referring to the pair configuration table 700, in all subsequent steps beyond this step 3102, it is not necessary to additionally refer to this table 700. In the case of transmitting plaintext, the processing flow proceeds to step 3111, while in the case of transmitting ciphertext, the processing flow proceeds to step 3103.

In step 3111, the remote copy processing unit 902 transmits an ordinary read request designating the transformed physical address obtained in step 3101 in disk I/O processing unit 913 to each target HDD 16. As a result, plaintext (one which is read after decrypting the stored ciphertext) is read from each target HDD 16.

On the other hand, in step 3103, the remote copy processing unit 902 transmits a non-encryption read request designating the transformed physical address obtained in step 3101 in disk I/O processing unit 913 to each target HDD 16. As a result, ciphertext (one which is read without decrypting the stored ciphertext) is read from each target HDD 16.

In step 3104, the remote copy processing unit 902 transmits the read data (in the form of ciphertext if after step 3103 or in the form of plaintext if after step 3111) to the secondary storage system 3. To transmit the read data, a write request for designating the LUN, WWN and LBA of the secondary LDEV, for example, can be used.

In step 3105, the remote copy processing unit 902 increases the address A of the primary LDEV to be read next by one.

In step 3106, the remote copy processing unit 902 judges whether or not the updated address A is the ending address of the primary LDEV. If it is, the processing flow ends, while if it is not, the processing flow returns to step 3101.

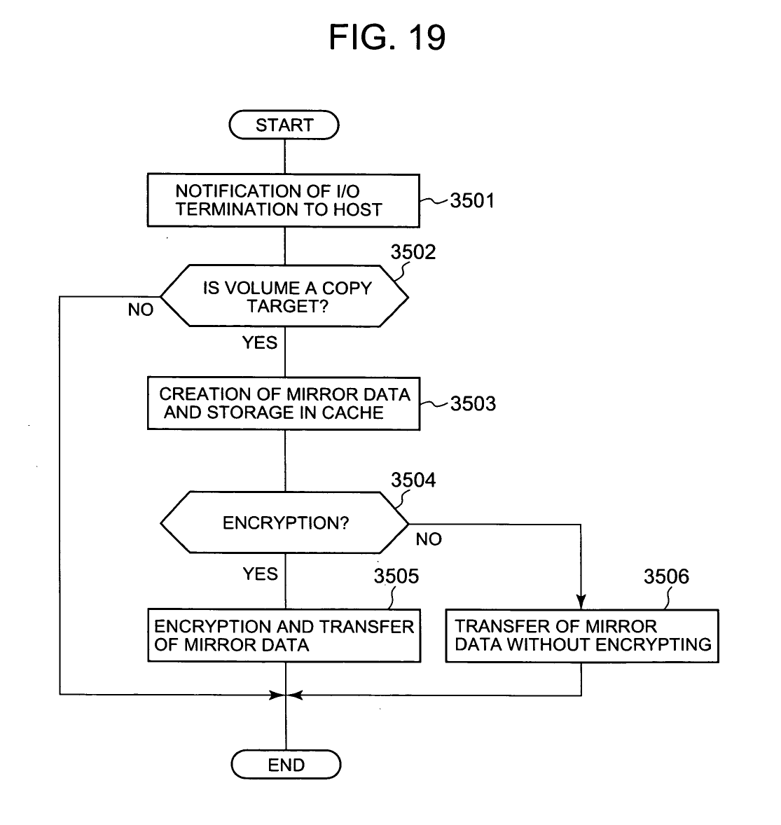

FIG. 19 shows an example of the flow of update copy processing. Furthermore, those various aspects of processing that have been previously explained are omitted from this FIG. 19.

Update copy processing refers to processing which is carried out in the case of storing new data in a primary LDEV whose copy status is in “pair” or “copy”.

For example, when the command processing unit 901 has stored plaintext (write data) received from the host 4, I/O termination can be informed to the host 4 without transmitting the plaintext to an HDD 16 (step 3500).

In step 3501, the command processing unit 901 judges whether or not an LDEV of a specified LDEV number is a copy target. More specifically, a judgment is made, for example, as to whether an LDEV corresponding to an LDEV number is an LDEV number of a primary LDEV, and whether the copy status is “pair” or “copy”, by referring to the pair configuration table 700 using a specified LDEV number. If the LDEV is a copy target, the command processing unit 901 sends out copying instructions to the remote copy processing unit 902, and the processing flow proceeds to step 3502, while if the LDEV is not a copy target, the processing flow ends since update copy processing is not required.

In step 3503, the remote copy processing unit 902 creates mirror data (replicates the plaintext) by duplicating the plaintext in the cache area, and then stores the created mirror data in the cache area.

In step 3504, the remote copy processing unit 902 judges whether or not the secondary LDEV of the copy destination is to be encrypted (by judging, for example, whether or not an encryption key corresponding to the secondary LDEV is registered in the pair configuration table 700). If the secondary LDEV is to be copied, the processing flow proceeds to step 3506, and if it is not to be copied, the processing flow proceeds to step 3507.

In step 3506, encryption transfer of the mirror data is carried out. More specifically, the remote copy processing unit 902, for example, acquires an encryption key corresponding to the secondary LDEV from the pair configuration table 700, and then notifies the controller E/D unit 124 of the acquired encryption key. The remote copy processing unit 902 then transmits a write request for the mirror data specifying the LUN, WWN and so on of the secondary LDEV to the secondary storage system 3 through an I/F 123 of the external adapter 12. As a result, the mirror data in the form of plaintext is transformed to ciphertext, and then transmitted to the secondary storage system 3.

On the other hand, in step 3507, non-encryption transfer of the mirror data is carried out. More specifically, the remote copy processing unit 902, for example, notifies the controller E/D unit 124 of a flag indicating non-encryption. The remote copy processing unit 902 then transmits a write request for the mirror data specifying the LUN, WWN and so on of the secondary LDEV to the secondary storage system 3 through an I/F 123 of the external adapter 12. As a result, the mirror data in the form of plaintext is transmitted directly to the secondary storage system 3 as the plaintext without being encrypted by the controller E/D unit 124.

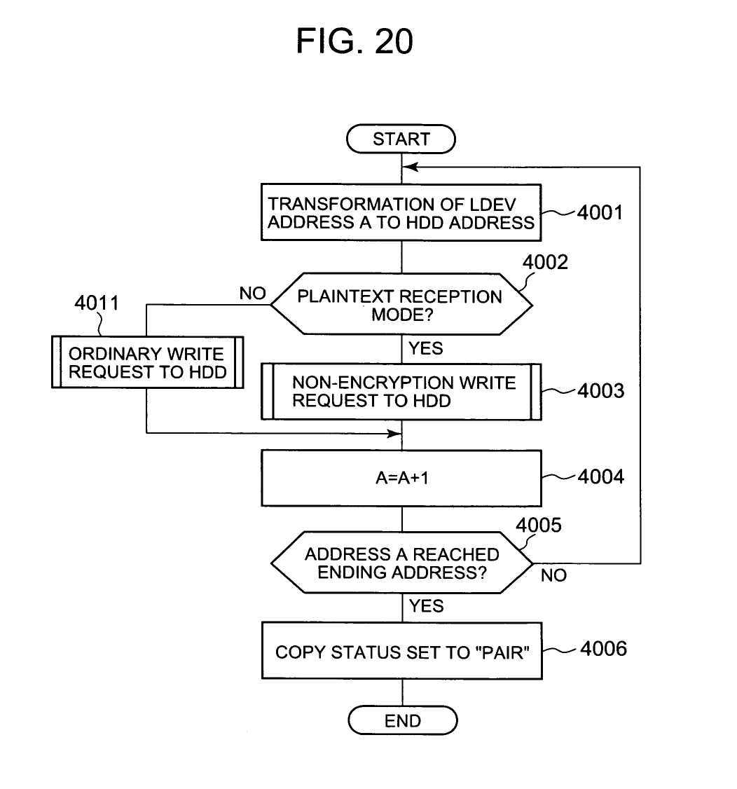

FIG. 20 shows an example of failback processing. Furthermore, each HDD corresponding to a VDEV containing a primary LDEV is referred to as a “target HDD” in the explanation of this FIG. 20.

Failback processing refers to processing which returns data in a secondary LDEV of the secondary storage system 3 to a primary LDEV. More specifically, when the storage system 1, for example, has gone down due to an accident and so on, operation is succeeded by the secondary storage system 3. In that case, if recovery processing of the storage system 1 has been completed, data can be recovered by copying data from the secondary storage system 3 to the storage system 1. The data copy processing at that time is called failback processing (an administrator can reconstruct the LU configuration table 600 in the case of carrying out failback processing after replacing the storage system 1 due to disaster and so on).

In this failback processing, for example, data copying is carried out with the primary LDEV designated as the copy destination and the secondary LDEV designated as the copy source.

As a specific example thereof, in step 4001, the remote copy processing unit 902 transforms an address A of a primary LDEV (such as the starting address at the start of copying) to a physical address (address in a target HDD) with the disk I/O processing unit 913.

In step 4002, the remote copy processing unit 902 judges whether or not processing is in the plaintext reception mode. If in the plaintext reception mode, this means that plaintext is received, while in the case a ciphertext is stored in a secondary LDEV (for example, in the case an encryption key is mapped to the secondary LDEV), operation takes place in a mode other than the plaintext reception mode.

In the case of a mode other than the plaintext reception mode, ciphertext is acquired from the secondary LDEV and stored in the cache area without being decrypted by the controller E/D unit 124. More specifically, as a result of the remote copy processing unit 902, for example, setting a value indicating that decryption is not required in the controller E/D unit 124, and then transmitting a read request for the secondary LDEV to the secondary storage system 3, the non-decrypted ciphertext is acquired by the controller E/D unit 124 and stored in the cache area. In this case, the processing flow proceeds to step 4003. In step 4003, the remote copy processing unit 903 instructs the disk I/O processing unit 913 to issue non-encryption write requests for the ciphertext in the cache area to each target HDD 16.

On the other hand, in the case of the plaintext reception mode, ciphertext acquired from the secondary LDEV is decrypted by the controller E/D unit 124 and the decrypted data (plaintext) is stored in the cache area. More specifically, as a result of the remote copy processing unit 902, for example, transmitting a read request for the secondary LDEV to the secondary storage system 3 without setting a value indicating that decryption is not required in the controller E/D unit 124, plaintext into which the ciphertext has been decrypted by the controller E/D unit 124 is acquired, and the plaintext is then stored in the cache area. In this case, the processing flow proceeds to step 4011. In step 4011, the remote copy processing unit 903 transmits an ordinary write request for the plaintext in the cache area to the disk I/O processing unit 913 and to each target HDD 16.

In step 4004, the remote copy processing unit 902 increases the address A of the primary LDEV to be written next by one.

In step 4005, the remote copy processing unit 902 judges whether or not the updated address A is the ending address of the primary LDEV. If it is, then the processing flow proceeds to step 4004, and copy status of the volume pair containing the primary LDEV is set to “pair”, while if it is not, the processing flow returns to step 4001.

The above has provided an explanation of a first embodiment.

According to this first embodiment, the storage system 1 is provided with the HDD 16 having the device E/D unit 921. When a write request from the host 4 is targeted to an external LDEV or a secondary LDEV (update copy processing in the present embodiment), plaintext is encrypted by the controller E/D unit 124. However, when it is targeted to an internal LDEV, plaintext is transmitted to the HDD 16 without being encrypted in the controller E/D unit 124. In this case as well, since the HDD 16 has the device E/D unit 921, the plaintext is encrypted by the device E/D unit 921 before it is stored into hard disk 927. As a result, deterioration of the performance of the controller 974 can be suppressed while realizing protection of data.

In addition, according to this first embodiment, although encryption is carried out by the controller E/D unit 124 during update copy processing, during initial copy processing, encryption by the controller E/D unit 124 is not required, and ciphertext within the HDD 16 is transmitted directly to the secondary storage system 3. Consequently, deterioration of the performance of the controller 974 during initial copy processing can be suppressed while realizing protection of data.

### Second Embodiment

The following provides an explanation of a second embodiment of the present invention. At this time, the explanation will focus primarily on differences with the first embodiment, while an explanation of common aspects with the first embodiment will be omitted or simplified.

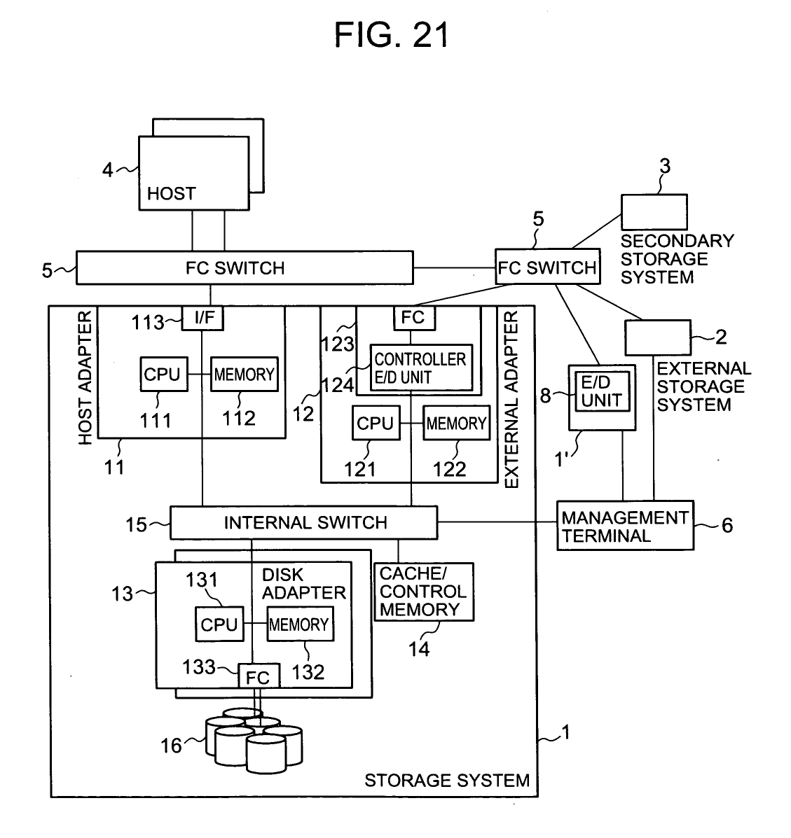

FIG. 21 shows an example of the physical configuration of a computer system as claimed in a second embodiment of the present invention.

According to this drawing, a storage system 1′ having an E/D (encryption/decryption) unit 8 serves as a storage system present outside the storage system 1. The storage system 1′ can be a type of external storage system 2 or secondary storage system 3.

In this case, the remote copy processing unit 902 or the command processing unit 901 is able to judge whether or not an external storage system serving as the transmission destination of a write request or a read request has an E/D unit 8. This can be determined by preparing a table representing whether or not each type of external storage system has an E/D unit, and having the remote copy processing unit 902 or the command processing unit 901 refer to that table. In the case the remote copy processing unit 902 or the command processing unit 901 has judged that the external storage system serving as the transmission destination has an E/D unit 8, plaintext can be transmitted without being encrypted by the controller E/D unit 124. In this case, the plaintext is encrypted and stored by the E/D unit 8 of that external storage system 1′. The E/D unit 8 may be an E/D unit provided in a controller, or an E/D unit provided in an HDD. In the case of transmitting without encrypting, the remote copy processing unit 902 or the command processing unit 901, for example, may notify the external storage system 1′ of an encryption key mapped to an external LDEV, primary LDEV or secondary LDEV, and then make the external storage system 1′ carry out encryption with the encryption key.

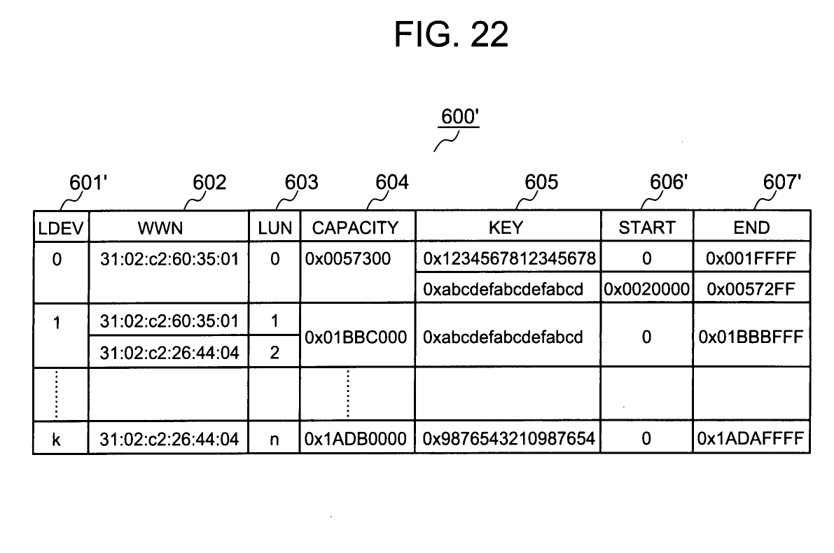

FIG. 22 shows an example of an LU configuration table in the second embodiment.

A plurality of encryption keys are mapped to a single LDEV in this LU configuration table 600′. A logical address range is then set for each of these encryption keys. More specifically, a column 606′ in which the starting address of the logical address range is written, and a column 607′ in which the ending address of the physical address range is written, are provided in the LU configuration table 600′.

In other words, in this second embodiment, a single LDEV is divided into a plurality of areas, and an encryption key can be mapped to each area.

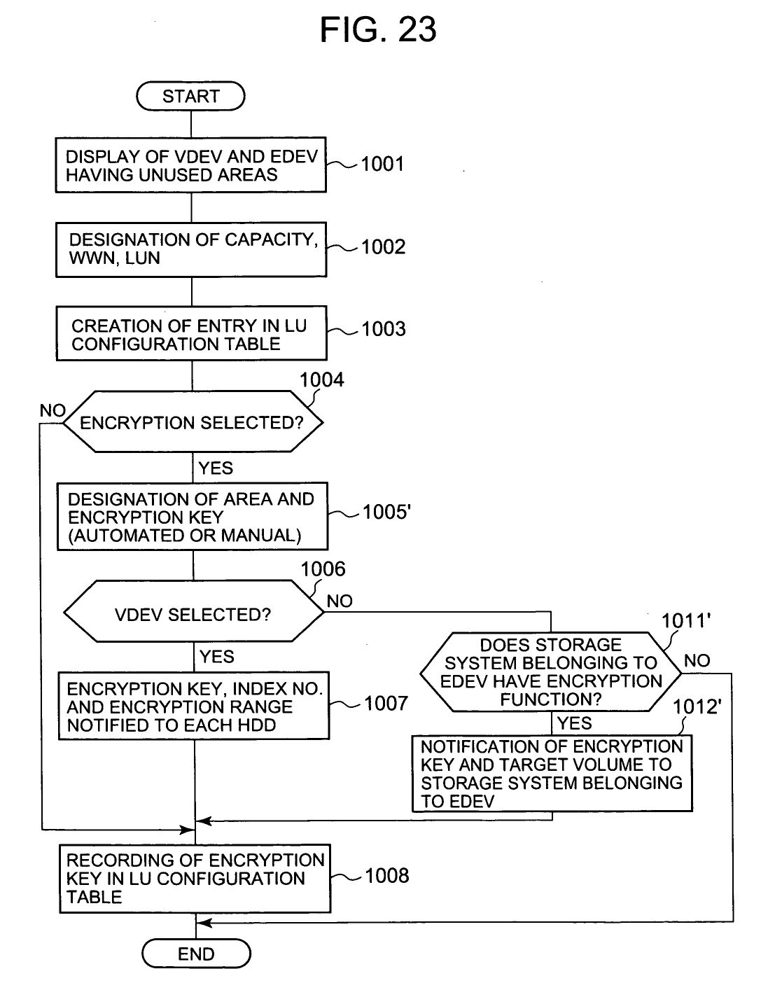

FIG. 23 shows an example of the flow of LDEV creation processing in the second embodiment. The following explanation primarily focuses on differences from the LDEV creation processing (FIG. 10) of the first embodiment.

Step 1005 in FIG. 10 is step 1005′ in FIG. 23. Namely, instead of encryption keys only, the logical address range of a target LDEV to which each encryption key is mapped is specified. Consequently, in step 1007, the physical address range corresponding to each logical address range is notified in the form of an encryption range to each target HDD 16.

In addition, steps 1011′ and 1012′ are carried out in the case of “NO” in step 1006 of FIG. 10 in the second embodiment.

In step 1011′, the table construction program judges whether or not the storage system to which the selected EDEV belongs has an encryption function (whether or not it has an E/D unit). In the case of having an encryption function, the processing flow proceeds to step 1012′, or ends in the case the EDEV does not have an encryption function.

In step 1012′, the table construction program notifies the storage system 1′ to which the EDEV belongs of the encryption key designated in step 1005′ and the target LDEV to which the encryption key is mapped. As a result, in the case plaintext has been transmitted to the storage system 1′, the E/D unit 8 of the storage system 1′ encrypts the plaintext with the encryption key mapped to the external LDEV and the encrypted data is stored in the storage system 1′.

The above has provided an explanation of a second embodiment of the present invention. Furthermore, although not shown in the drawings, as was previously described, the command processing unit 901 or the remote copy processing 902 judges whether or not a storage system serving as the transmission destination of a write request or read request in an external storage connection or remote copy has an encryption function, and in the case it does not have an encryption function, ciphertext encrypted by the controller E/D unit 124 is transmitted, while in the case of being provided with an encryption function, the plaintext is transmitted directly without being encrypted by the controller E/D unit 124. As a result, deterioration of the performance of the controller 974 can be suppressed.

### Third Embodiment

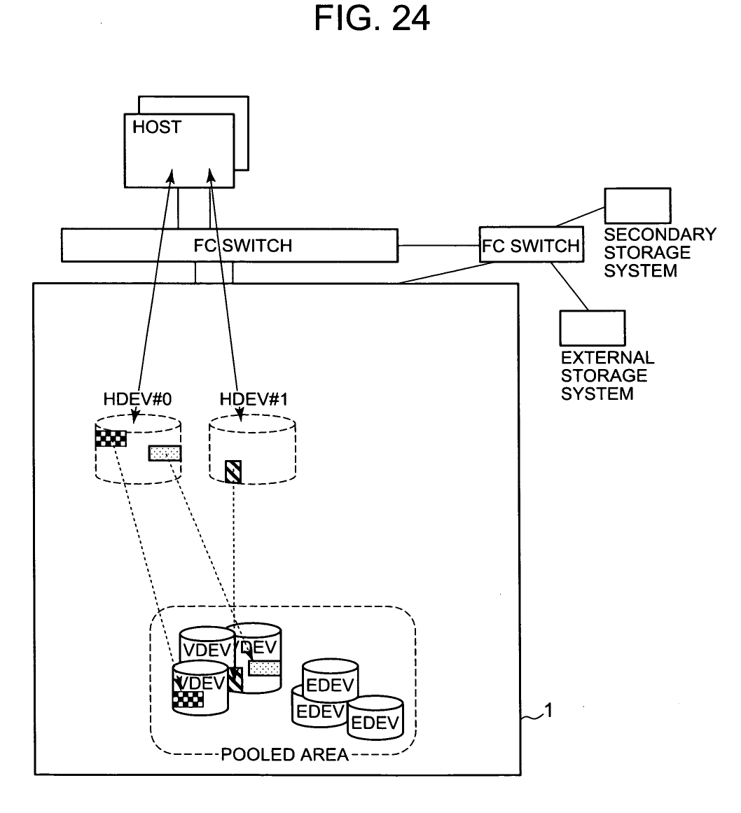

FIG. 24 is an explanatory drawing of an automatic capacity expansion technology in a third embodiment of the present invention.

Automatic capacity expansion technology refers to dynamic assignment/release of disk blocks in a pooled area to/from an HDEV in response to write operations, which is capable of dynamically expanding the usage capacity of an HDEV. This technology is also referred to as thin provisioning. Although the following provides a brief explanation of an example thereof, examples of automatic capacity expansion technologies can also be referred to from the disclosures of Japanese Patent Application Laid-open Publication No. 2003-15915 (U.S. Pat. No. 6,725,328, U.S. Pat. No. 6,836,819 and U.S. patent application Ser. No. 10/991421).

An HDEV is provided to the host 4 by a storage system 1 (for example, the host adapter 11). HDEV is the abbreviation for higher device. HDEV is a name used for the sake of convenience having the meaning of being located upstream from the above-mentioned VDEV. The HDEV can be a virtual logical volume. In this embodiment, an LU for the host 4 is a virtual logical volume thereof in the form of an HDEV.

A pooled area is prepared in the storage system 1. The pooled area is a collection of VDEVs or EDEVs. This pooled area is composed of a large number of disk blocks (or logical areas without being limited to disk blocks). Among the large number of disk blocks, the disk blocks which have not yet been assigned are dynamically assigned to the HDEV.

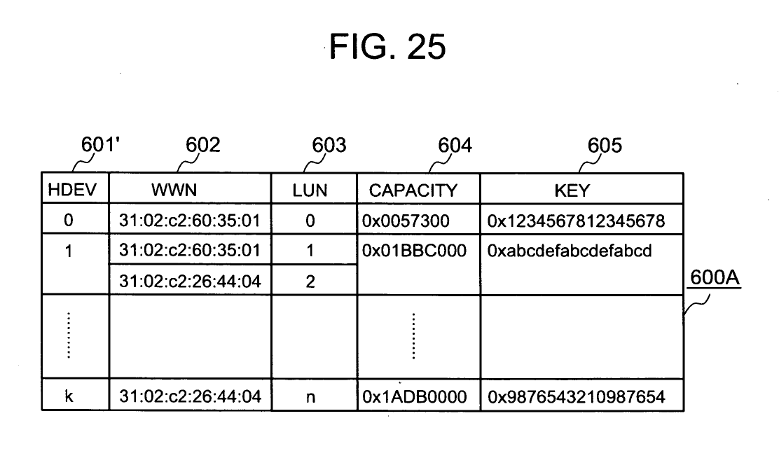

FIG. 25 shows an example of the configuration of an HDEV configuration table.

An HDEV configuration table 600A is a table for managing data relating to HDEV configuration, and is stored, for example, in the cache/control memory 14. The configuration of this table 600A is similar to that of the LU configuration table 600 explained with reference to FIG. 7. The difference between this table and the HDEV configuration table 600A is that, instead of the column 601 in which LDEV numbers are written, a column 601′ is prepared in which HDEV numbers (HDEV identifiers) are written. In this embodiment, an encryption keys is mapped to each HDEV.

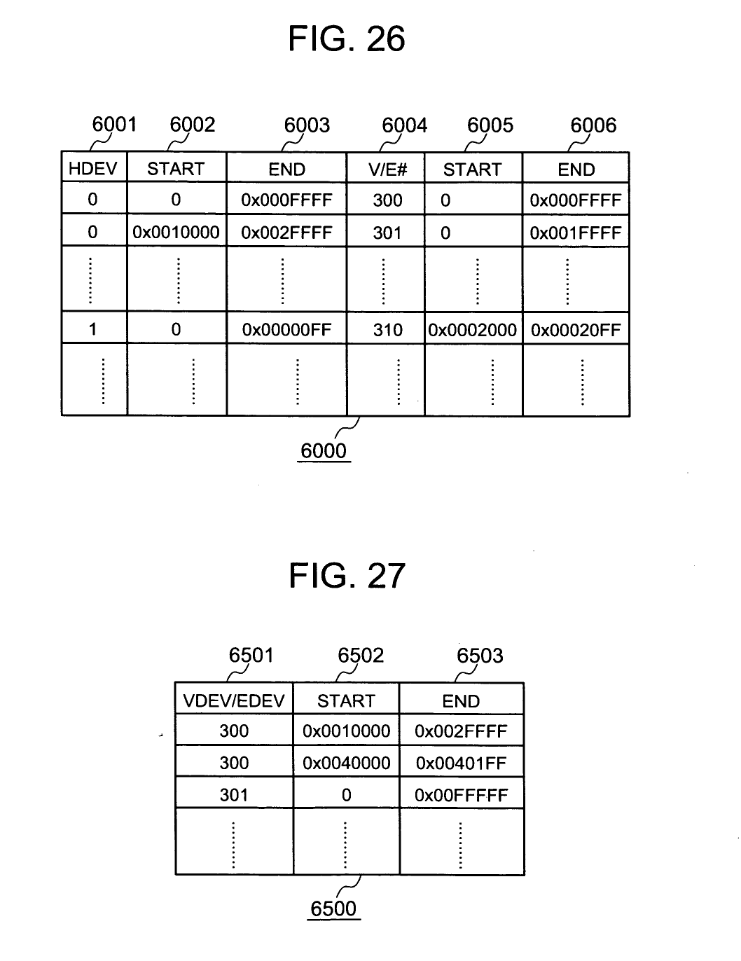

FIG. 26 shows an example of the configuration of an assignment management table.

An assignment management table 6000 is a table for managing those portions for the HDEV to which disk blocks are assigned, and is stored, for example, in the cache/control memory 14. More specifically, this table 6000 has, for example, a column 6001 in which HDEV numbers are written, a column 6002 in which the starting addresses of the logical address ranges of the HDEV (representing an area of the HDEV and indicating the HDEV address range) are written, a column 6003 in which the ending addresses of the logical address ranges of the HDEV are written, a column 6004 in which the identification numbers of the VDEVs or the EDEVs having disk blocks assigned to the HDEV are written, a column 6005 in which the starting addresses of the assigned disk blocks are written, and a column 6006 in which the ending addresses of the assigned disk blocks are written.

FIG. 27 shows an example of the configuration of a pooled area management table.

A pooled area management table 6500 is a table for managing unassigned disk blocks in the pooled area, and is stored, for example, in the cache/control memory 14. More specifically, this table 6500 has, for example, a column 6501 in which the identification numbers of the VDEVs or the EDEVs having unassigned disk blocks are written, a column 6502 in which the starting addresses of unassigned disk blocks are written, and a column 6503 in which the ending addresses of unassigned disk blocks are written.

When an unassigned disk block is assigned to an HDEV, each entry corresponding to the disk block is deleted from the pooled area management table 6500, and each of those entries is added to the assignment management table 6000. Conversely, when the assignment of a disk block to an HDEV has been canceled, each entry corresponding to that disk block is deleted from the assignment management table 6000, and each of those entries is added t the pooled area management table 6500. This series of dynamic assignment and cancellation can be carried out, for example, by the command processing unit 901 or the remote copy processing unit 902.

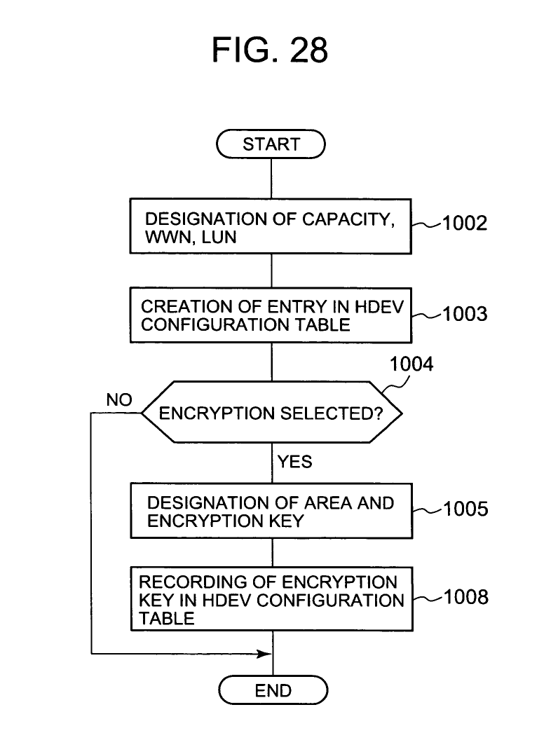

FIG. 28 shows an example of the flow of HDEV creation processing. The following explanation focuses primarily on differences with the LDEV creation table (FIG. 10) of the first embodiment.

Step 1001 in FIG. 10 is not required. This is because HDEV are not created from the VDEV or EDEV.

In step 1003, the HDEV configuration table 600A is constructed.

In the case encryption has been selected in step 1004, an area (for example, an HDEV number) and an encryption key are designated in step 1005. The encryption key may be generated automatically, or it may be received from an administrator.

In step 1008, the encryption key designated for the designated area is mapped to the HDEV configuration table 600A.

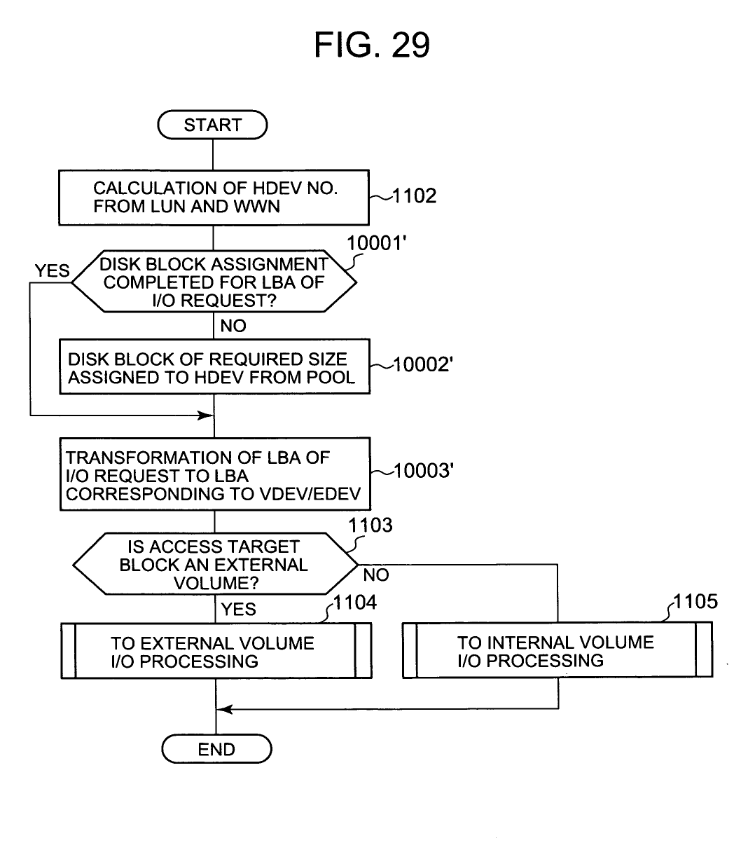

FIG. 29 shows an example of the flow of processing carried out in the case an I/O request has been received by the host adapter 11 from the host 4 in the third embodiment. The following explanation focuses primarily on differences from FIG. 11.

New steps consisting of step 10001′ to step 10003′ are carried out between step 1102 and step 1103.

In step 10001′, the command processing unit 901 judges whether or not a disk block has been assigned to the LBA specified in the I/O request by referring to the assignment management table 6000. If a disk block has been assigned, the processing flow proceeds to step 10003′, and if a disk block has not yet been assigned, the processing flow proceeds to step 10002′.

In step 10002′, the command processing unit 901 specifies a number of unassigned disk blocks of the required size from the pooled area management table 6500, and assigns the specified disk blocks to an HDEV.

In step 10003′, the command processing unit 901 transforms the LBA specified with the I/O request to the LBA of the assigned disk blocks.

In step 1103, a judgment is made as to whether the disk blocks assigned to the LBA designated with the I/O request (in other words, the access target blocks) belong to an VDEV or EDEV. In the case of belonging to an VDEV, internal LDEV I/O processing is carried out, while in the case of belonging to an EDEV, external LDEV I/O processing is carried out.

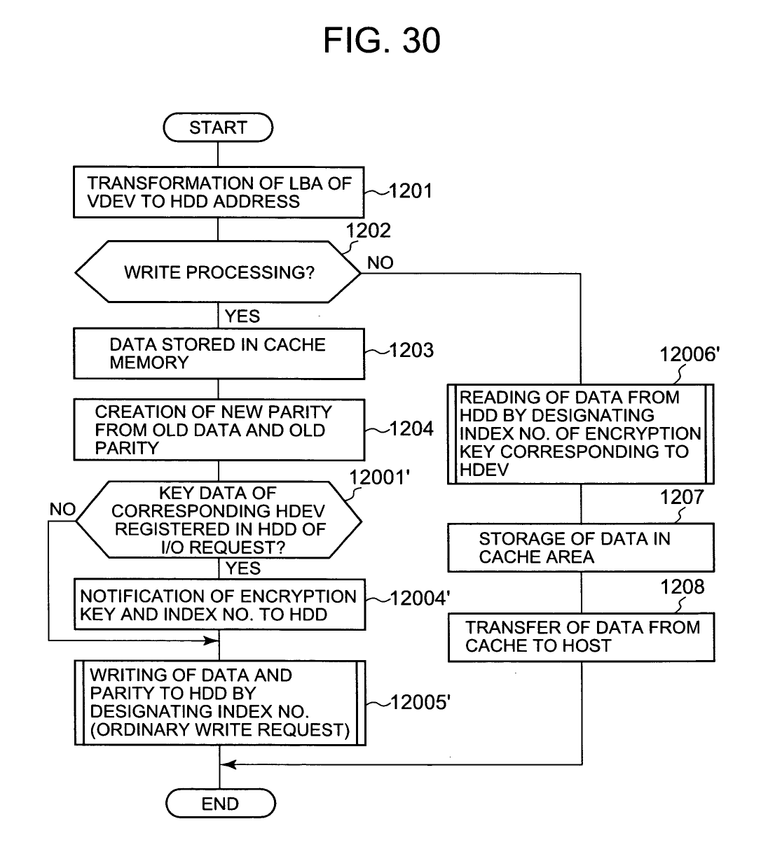

FIG. 30 shows an example of the flow of internal LDEV I/O processing in the third embodiment. Key differences from FIG. 12 are explained below.

In step 1201, address transformation is carried out on the LBA of the access target blocks. Steps 12001′ and 12004′ are carried out between steps 1204 and 1205, and step 12005′ is carried out in step 1205. In addition, in the case of NO in step 1202, step 12006′ is carried out instead of step 1206.

In step 12001′, the command processing unit 901 judges whether or not the physical address range containing the physical address corresponding to the newly assigned disk block LBA, and the encryption key mapped to the physical address range, are registered in the key management table 160 of the target HDD 16. Here, in the case of having already been assigned in step 10001′ of FIG. 29, for example, the physical address range and encryption key can be judged to be registered, while in the case of not being assigned, can be judged not to be registered. In the case of being registered, the processing flow proceeds to step 12005′, while in the case of not being registered, the processing flow proceeds to step 12004′.

In step 12004′, the command processing unit 901 makes the disk I/O processing unit 913 notifies the HDD 16 having the physical address range corresponding to the newly assigned disk block in step 10002′ of an index number and encryption key pair. As a result of this processing, the encryption key mapped to the same physical address range in the key management table 160 of the HDD 16 can be changed dynamically. Here, there is a table, for example, in which index numbers mapped for each disk block are recorded, and the disk I/O processing unit 913 is able to specify an index number corresponding to an assigned disk block from that table, and notify that index number and encryption key corresponding to the HDEV where it is assigned. Furthermore, a method similar to that of the first embodiment, namely a method for designating a physical address range, may be used instead of this method.

In step 12005′, the disk I/O processing unit 913 transmits a write request for new data and new parity designating an index number corresponding to a disk block containing the LBA obtained by step 10003′ to each target HDD 16. Furthermore, in this embodiment, the write request designating an index number is an ordinary write request, while a write request not designating an index number (which designates a physical address range, for example, instead) is a non-encryption write request.

In step 12006′, the disk I/O processing unit 913 transmits a read request designating an index number corresponding to a disk block containing the LBA obtained by step 10003′ to each target HDD 16. Furthermore, in this embodiment, a read request designating an index number is an ordinary read request, while a read request not designating an index number (which designates a physical address range, for example, instead) is a non-decryption read request.

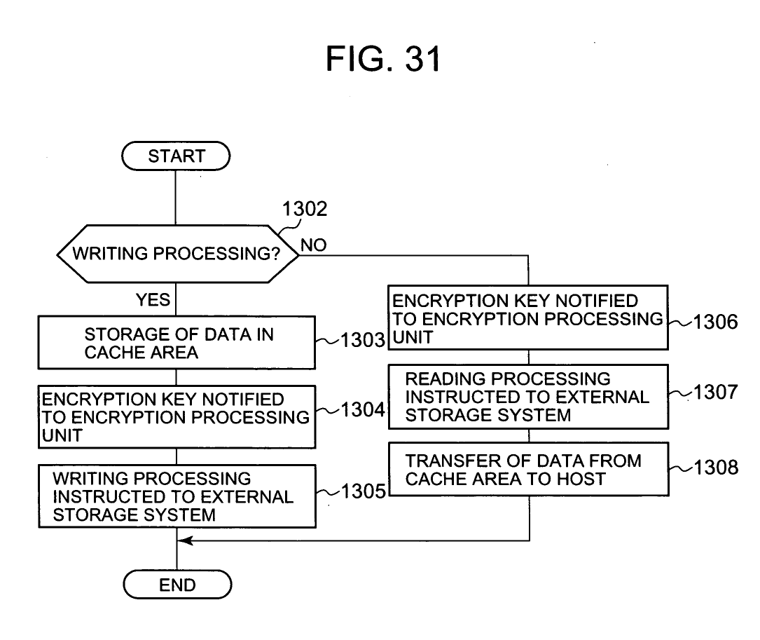

FIG. 31 shows an example of the flow of external LDEV I/O processing in the third embodiment. The following explanation focuses primarily on differences with FIG. 13.

The processing of step 1301 is not required. This is because the LBA in the EDEV corresponding to the LBA designated with the I/O request from the host 4 has already been obtained in step 10003′ of FIG. 29.

The above has provided an explanation of a third embodiment of the present invention. According to this third embodiment, deterioration of the performance of the controller 974 can be suppressed while realizing protection of data even when using automatic capacity expansion technology.

### Fourth Embodiment

In a fourth embodiment of the present invention, remote copying is carried out using journal data. The following explanation is merely an example of remote copying using journal data, and there is no need to limit the present invention thereto.

Journal data contains, for example, plaintext written to a primary LDEV, an update sequence information (for example, a number or timestamp), and an LDEV number of a primary LDEV. For example, in the case this journal data is generated and written to a journal LDEV in the case of having received a plaintext write request for the primary LDEV. The journal data within the journal LDEV is then transmitted to the secondary storage system 3. Although the journal LDEV in the present embodiment is an internal LDEV, it is applicable when the journal LDEV is an external LDEV.

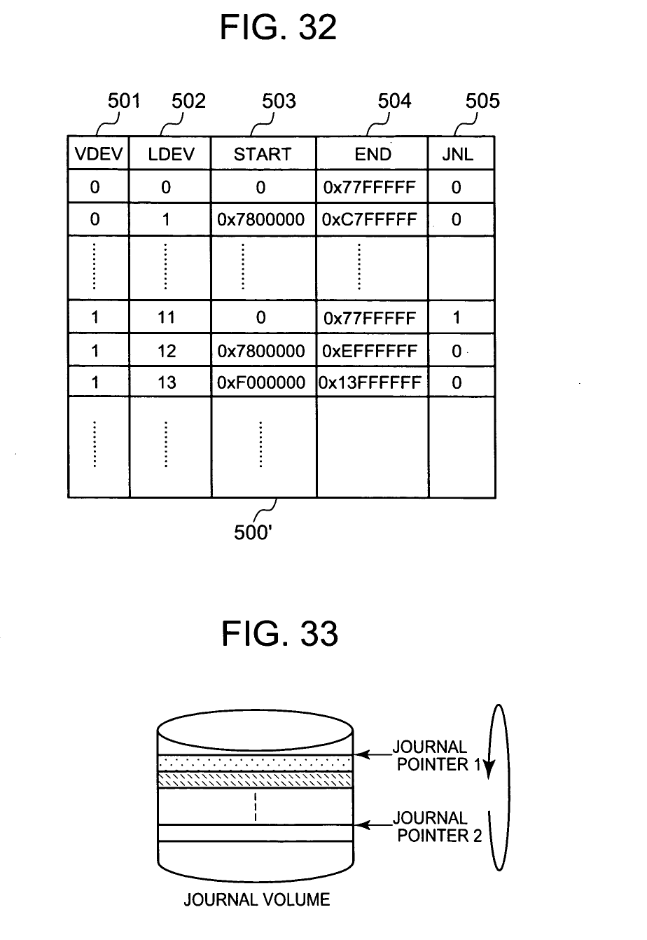

FIG. 32 shows an example of the configuration of a VDEV configuration table in the fourth embodiment.

A VDEV configuration table 500′ has a column 505 in which a value indicating whether or not the LDEV is a journal LDEV is written. In the case this value is 1, the corresponding LDEV is indicated as being a journal LDEV.

FIG. 33 is an explanatory drawing of a pointer for a journal LDEV.

In the present embodiment, journal data transferred to the secondary storage system 3 is written to this journal LDEV in order starting with the first data. The journal data is read in order starting from the first data of the journal LDEV and then transferred to the secondary storage system 3. This processing can be carried out by the remote copy processing unit 902.

In the present embodiment, two types of pointers (to be referred to as journal pointers 1 and 2) are prepared for the journal LDEV.

A journal pointer 2 represents the location of the writing destination of new journal data. Namely, in the present embodiment, in order to determine the location where new journal data is to be written, the remote copy processing unit 902 has a variable referred to as “journal pointer 2”, and is maintained and managed so that this journal pointer 2 indicates the location where new journal data is to be written. When the journal pointer 2 reaches the end of the journal LDEV, the journal pointer 2 returns to the beginning.

On the other hand, a journal pointer 1 represents the start of the location of a reading source. The journal pointer 1 is updated to the next address each time journal data is read and transferred to the secondary storage system 3.

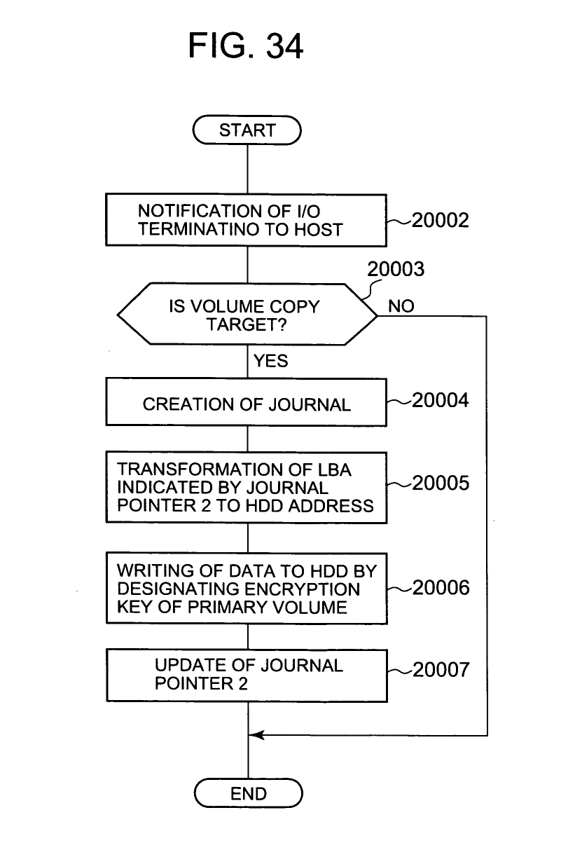

FIG. 34 shows an example of journal writing processing.

In this embodiment, this journal writing processing of FIG. 34 is carried out instead of the update copy processing of FIG. 19.

More specifically, if plaintext from the host 4 has been stored in a cache area by the command processing unit 901, then the host 4 is notified of I/O termination (step 20002).

If the writing destination of that plaintext is a primary LDEV (YES in step 20003), then the remote copy processing unit 902 creates journal data containing the plaintext (step 20004).

Next, the remote copy processing unit 902 transforms the LBA indicated by the journal pointer 2 to a physical address (address in each HDD 16 corresponding to the VDEV containing the journal LDEV) in the disk I/O processing unit 913 (step 20005).

Next, the remote copy processing unit 902 maps the encryption key of the primary LDEV and the physical address range containing the transformed physical address with the key management table 160 with the disk I/O processing unit 913, and then stores the created journal data at that physical address. As a result, the journal data is encrypted with that encryption key and stored by the device E/D unit 921 of the HDD 16 (step 20006).

Finally, the remote copy processing unit 902 updates the journal pointer 2 (step 20007).

Furthermore, in step 20006, in the device E/D unit 921, only a portion of the plaintext (for example, data starting with the header of the journal data) may be encrypted instead of encrypting all of the journal data. As a result, in the case of reading the encrypted journal data, since data other than the plaintext is not encrypted, it is possible to specify the primary LDEV in which the ciphertext in the journal data is located.

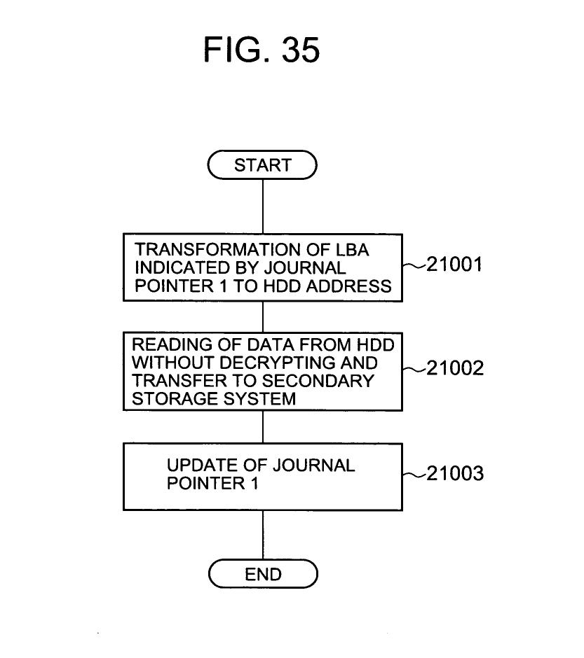

FIG. 35 shows an example of journal copy processing.

This journal copy processing is carried out periodically independent of, for example, the journal writing processing of FIG. 34.

In step 21001, the remote copy processing unit 902 transforms the LBA indicated by the journal pointer 1 to a physical address with the disk I/O processing unit 913.

In step 21002, the remote copy processing unit 902 instructs the disk I/O processing unit 913 to read the journal data from the physical address without decrypting the journal data. As a result, if the journal data that is not decrypted is read, that journal data is transmitted to the secondary storage system 3.

Finally, the remote copy processing unit 902 updates the journal pointer 1.

The above has provided an explanation of the fourth embodiment. Furthermore, in this fourth embodiment, the secondary storage system 3 is able to restore the encrypted cipher text in the journal data to a secondary LDEV.

According to this fourth embodiment, deterioration of the performance of the controller 974 can be suppressed while realizing protection of data even when using remote copying technology using a journal.

### Fifth Embodiment

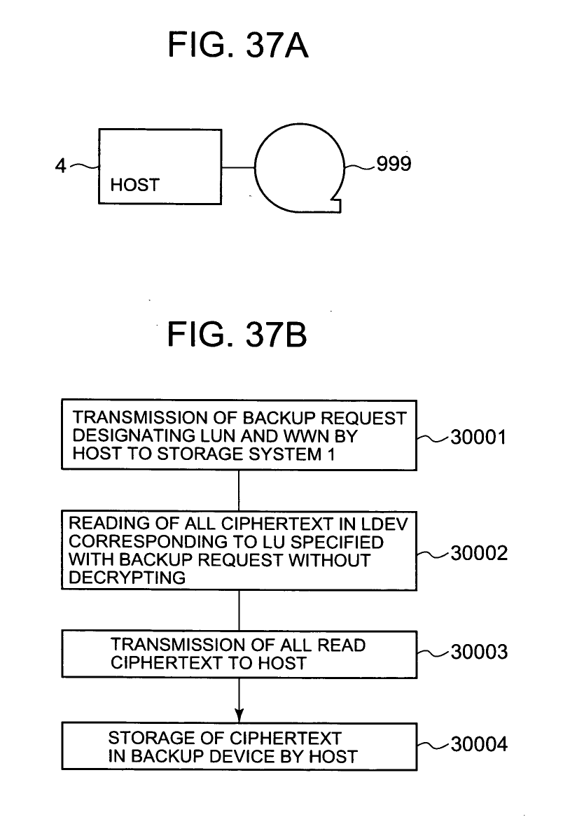

In a fifth embodiment of the present invention, a data backup device 999 is connected to the host 4 as shown in FIG. 37A. This backup device 999 may be, for example, a magnetic tape device (such as a tape library device provided with a plurality of tape media), or another type of device.

As shown in FIG. 37B, the host 4 transmits a backup request designating a desired LU to the storage system 1 (step 30001).

In this case, all data in the LDEV corresponding to that LU is read while still in ciphertext (step 30002) and transmitted to the host 4 (step 30003).

The host 4 then stores the read ciphertext in the backup device 999 (step 30004).

While preferred embodiments of the invention has been described and illustrated above, it should be understood that these are exemplary of the invention, and are not to be considered as limiting. Additions, omission, substitutions and other modifications can be made without departing from the spirit or scope of the present invention. For example, although the same encryption key is used for both encryption and decryption, separate key may also be prepared in the form of an encryption key and a decryption key instead.

1. A first storage system coupled to an upper-level device which transmits a write request to write data and a second storage system provided with one or more second logical volumes prepared based on a plurality of second storage devices, comprising:
a plurality of first storage devices;
one or more first logical volumes prepared based on the plurality of first storage devices; and
a controller which receives and processes writing requests from the upper-level device; wherein
each of the plurality of first storage devices has a storage medium and a device encryption processing unit which encrypts data written to the storage medium;
the controller comprises a controller encryption processing unit which encrypts data, and an access control unit which controls writing of data according to a write request received from the upper-level device;
the access control unit judges which of the first logical volumes or which of the second logical volumes is to serve as a writing destination in the case of having processed the received write request, transmits write data according to the write request to a first storage device corresponding to the first logical volume serving as the writing destination without encrypting with the controller encryption processing unit if the writing destination is the first logical volume, while on the other hand, transmits write data according to the write request to the second storage system after being encrypted by the controller encryption processing unit if the writing destination is the second logical volume.

2. The storage system according to claim 1, wherein the controller further comprises a cache storage area which temporarily stores the write data, and
in the case write data in the cache area is transmitted to the second storage system, the access control unit encrypts the writing target with the controller encryption processing unit.

3. The storage system according to claim 1, wherein each of the first storage devices has an encryption key storage area in which a physical address range and an encryption key are set, and the device encryption processing unit is composed so as to encrypt write data written to a certain physical address range of the storage media using an encryption key corresponding to the certain physical address in the encryption key storage area,
the controller has an encryption key setting unit which sets a physical address range and an encryption key in the encryption key storage area, and
the encryption key setting unit sets a physical address range corresponding to each of a plurality of logical address ranges and an encryption key corresponding to the logical address range in the encryption key storage area of the plurality of first storage devices.

4. The storage system according to claim 3, wherein a storage space portion represented with one of the logical address ranges is one of the first logical volumes.

5. The storage system according to claim 3, wherein one of the first logical volumes is composed by two or more storage space portions respectively represented with two or more of the logical address ranges.

6. The storage system according to claim 3, wherein
each of the first storage devices comprises a device decryption processing unit, the device decryption processing unit is composed so as to decrypt encrypted data read from a certain physical address range in the storage medium of the first storage device with an encryption key associated with the physical address range in the encryption key storage area,
the controller has a management storage area which stores management data for managing the first storage system, and the management data contains encryption keys associated with each of the plurality of logical address ranges,
the access control unit is composed so as to transmit write data stored in a first logical address range of the first storage system to the second storage system for storing in a second logical address range of the second storage system,
transmits encrypted data without decrypting with the device decryption processing unit of the first storage device, and without encrypting with the controller encryption processing unit by reading the encrypted data from the first storage device in the case of reading the encrypted data from a physical address range in a storage medium of the first storage device corresponding to the first logical address range, and transmitting the data to the second storage system,
transmits encrypted write data to the second storage system by specifying an encryption key corresponding to the first logical address range from the management data, and having the write data encrypted by the controller encryption processing unit with the specified encryption key in the case of writing new write data to the first logical address range.

7. The storage system according to claim 1, wherein
there is a virtual volume which is a virtual logical volume not prepared based on the plurality of first storage devices, and one or more of the second logical volumes is associated with the virtual volume, and
the access control unit encrypts write data according to a write request with the controller encryption processing unit in the case of processing the write request for the virtual volume, while on the other hand, in the case of processing a write request for an actual first logical volume, transmits write data in accordance with the write request to a first storage device corresponding to the actual first logical volume without encrypting with the controller encryption processing unit.

8. The storage system according to claim 1, wherein
the access control unit judges whether or not an encryption processing unit for encrypting data is provided in the second storage system having a second logical volume serving as the writing destination, and in the case of being provided therewith, transmits the write data to the second storage system without encrypting with the controller encryption processing unit.

9. The storage system according to claim 1, wherein
each of the first storage devices comprises a device decryption processing unit, the device decryption processing unit is composed so as to decrypt encrypted data read from the storage medium of the first storage device, and
in the case the access control unit is composed so as to carry out a first copy by forming a volume pair comprising a certain first logical volume as a copy source volume and a certain second logical volume as a copy destination volume, reading data stored in the copy source volume from a first storage device corresponding to the copy source volume and transmitting the data to the second storage system, during the first copy, encrypted write data stored in a first storage device corresponding to the copy source volume is read without decrypting with the device decryption processing unit of the first storage device, and then transmitted to the second storage system without encrypting with the controller encryption processing unit.

10. The storage system according to claim 9, wherein
in the case the access control unit is composed so as to carry out a second copy by transmitting newly written write data to the second storage system in the case the write data is newly written to the copy source volume after the first copy, during this update copy, the newly written write data is encrypted in the controller encryption processing unit and then transmitted to the second storage system.

11. The storage system according to claim 9, wherein
the controller encryption processing unit encrypts the newly written write data with an encryption key used for data encryption associated with the copy destination volume or the copy source volume.

12. The storage system according to claim 1, wherein
the controller further comprises a controller decryption processing unit which decrypts data, and
in the case of carrying out data copy with the second logical volume as a copy source volume and the first logical volume as a copy destination volume, the access control unit writes encrypted data directly to a first storage device corresponding to the copy destination volume without carrying out decryption by the controller decryption processing unit and without carrying out encryption by the device encryption processing unit in the case data within the copy source volume is the encrypted data.

13. The storage system according to claim 1, wherein
the access control unit, in the case of forming a volume pair comprising a certain first logical volume as a copy source volume and a certain second logical volume as a copy destination volume, and writing write data to the copy source volume, is composed so as to copy write data within the copy source volume to the copy destination volume by generating journal data containing the write data, writing the generated journal data to a different first logical volume in a form of a journal volume, reading journal data stored in the journal volume from a first storage device with the journal data, and transmitting the read journal data or write data within the journal data to the second storage system,
each of the first storage devices has an encryption key storage area, in which are set the physical address range and encryption key, and a device decryption processing unit, the device decryption processing unit is composed so as to decrypt write data written to a certain physical address range of the storage medium using an encryption key corresponding to the certain physical address range in the encryption key storage area, and the device decryption processing unit is composed so as to decrypt encrypted data read from a certain physical address range in the storage medium of the first storage device with an encryption key associated with the certain physical address range in the encryption key storage area,
the controller has a management storage area which stores management data for managing the first storage system, and an encryption key setting unit which sets an encryption key in the encryption key storage area,
the management data contains encryption keys associated with each of a plurality of copy source volumes, and
the encryption key setting unit sets a physical address range corresponding to a writing destination of the journal data, and an encryption key corresponding to a copy source volume in which write data is written within the journal data, in a storage area of the device controller of a first storage device with the physical address range.

14. The storage system according to claim 13, wherein
the access control unit transmits the journal data to the second storage system by reading the journal data without decrypting with the device decryption processing unit of the first storage device.

15. The storage system according to claim 1, wherein
the access control unit is composed so as to assign an unassigned logical area among a plurality of logical areas composing a logical storage space composed by one or more of the first logical volumes to a logical volume in a form of a virtual volume, or unassign an assigned logical area by canceling assignment thereof, and if the logical area is not assigned to a location in the virtual volume designated with a write request for the virtual volume, assigns an unassigned logical area among the plurality of logical areas, and transmits write data according to the write request to a first storage device having a physical address range corresponding to the assigned logical area,
each of the first storage devices has an encryption key storage area in which the physical address range and encryption key are set, and the device encryption processing unit is composed so as to encrypt write data written to a certain physical address range of the storage medium using an encryption key corresponding to the certain physical address range in the encryption key storage area,
the controller has an encryption key setting unit which sets a physical address and an encryption key in the encryption key storage area,
there are a plurality of the virtual volumes, and
the encryption key setting unit sets a physical address range corresponding to an assigned logical area and an encryption key corresponding to a virtual volume of an assignment destination of the logical area to the encryption key storage area of a first storage device with the physical address range.

16. The storage system according to claim 15, wherein each of the first storage devices comprises a device decryption processing unit, the device decryption processing unit is composed so as to decrypt encrypted data read from a certain physical address range in the storage medium of the first storage device with an encryption key associated with the physical address range in the encryption key storage area, and
in the case of having received a read request for the virtual volume from the upper-level device, the access control unit specifies the assigned logical area to a location in the virtual volume designated with the read request, specifies a physical address range corresponding to the logical area, reads data from the specified physical address area in the storage medium of the first storage device, and then provides the data to the upper-level device.

17. The storage system according to claim 1, wherein
each of the first storage devices comprises a device decryption processing unit, the device decryption processing unit is composed so as to decrypt encrypted data read from the storage medium of the first storage device,
the controller has a subsystem decryption processing unit which decrypts encrypted data, and
in the case a reading source in the case of having processed a read request from the upper-level device is any of the second logical volumes, the access control unit is composed so as to decrypt encrypted data read from the second logical volume using the subsystem decryption processing unit, and
in the case of having received a backup request requiring reading processing of data within the first or the second logical volume, the access controller acquires encrypted data without using the device decryption processing unit or the subsystem decryption processing unit, and transmits the acquired encrypted data to the upper-level device.

18. The storage system according to claim 1, wherein
a plurality of the first logical volumes are formed by dividing a total storage space of an aggregation of each storage space of the plurality of first storage devices, and one of the first logical volumes is composed by a portion of the storage space of each of the storage devices,
each of the first storage devices has an encryption key storage area in which the physical address range and encryption key are set, and the device encryption processing unit is composed so as to encrypt write data written to a certain physical address range of the storage medium using an encryption key corresponding to the certain physical address range in the encryption key storage area,
the controller comprises a cache storage area which temporarily stores the write data, and an encryption key setting unit which sets a physical address range and an encryption key in the encryption key storage area,
the access control unit encrypts write data using the controller encryption processing unit in the case of transmitting the write data in the cache area to the second storage system, and
the encryption key setting unit sets a plurality of encryption keys corresponding to each of a plurality of first logical volumes each having a plurality of portions of a storage space of the first storage device, and a plurality of physical address ranges corresponding to each of the plurality of portions in the encryption key storage area of each of the first storage devices.

19. A storage control method realized with a computer system comprising an upper-level device which transmits a write request for write data, a second storage system provided with one or more logical volumes prepared based on a plurality of second storage devices, and a first storage system, which is connected to the upper-level device and the second storage system, and is provided with one or more first logical volumes prepared based on a plurality of first storage devices, comprising:
a step in which the first storage system receives a write request transmitted from the upper-level device;
a step in which a judgment is made as to whether a writing destination in the case of having processed the write request is any of the first logical volumes or any of the second logical volumes;
a step in which if the writing destination is any of the first logical volumes, write data according to the write request is transmitted to a first storage device corresponding to the first logical volume of the writing destination without being encrypted in an encryption processing unit provided in a controller of the first storage system, and as a result, the write data is encrypted by an encryption processing unit of the first storage device; and
a step in which if the writing destination is any of the second logical volumes, the write data is encrypted by the encryption processing unit provided in the controller, and transmitted to the second storage system.

20. The storage control method according to claim 19, comprising:
a step in which a volume pair is formed comprising a first logical volume as a copy source volume and a second logical volume as a copy destination volume;
a step in which encrypted data stored in the copy source volume is read without being decrypted by a decryption processing unit of the first storage device; and
a step in which the encrypted data is stored in the second logical volume without being encrypted by the encryption processing unit provided in the controller.
